(19) United States
(12) Patent Application Publication
(10) Pub. No.: US 2013/0314695 A1
(43) Pub. Date: Nov. 28, 2013

(54) Spectral Analysis Techniques Based Upon Spectral Monitoring of a Matrix

(71) Applicants: Melissa Weston, Duncan, OK (US); Kurt Hoeman, Duncan, OK (US); Robert P. Freese, Pittsboro, NC (US); Johanna Haggstrom, Duncan, OK (US)

(72) Inventors: Melissa Weston, Duncan, OK (US); Kurt Hoeman, Duncan, OK (US); Robert P. Freese, Pittsboro, NC (US); Johanna Haggstrom, Duncan, OK (US)

(73) Assignee: Halliburton Energy Services, Inc., Houston, TX (US)

(21) Appl. No.: 13/479,982

(22) Filed: May 24, 2012

(51) Int. Cl. G01J 3/28

(52) U.S. Cl. 356/51; 356/402

(57) ABSTRACT

Spectroscopic analyses of complex mixtures within the matrix of a sample can oftentimes be complicated by spectral overlap of the constituents and/or the matrix, making it difficult to quantitatively assay each constituent therein. Methods for analyzing a sample can comprise: providing a sample comprising a matrix and one or more constituents therein; exposing the sample to electromagnetic radiation in a spectral region where the matrix optically interacts with the electromagnetic radiation, so as to acquire a spectrum of the matrix; and analyzing the spectrum of the matrix within a wavelength range where the matrix has a molar extinction coefficient of at least about 0.01 M⁻¹mm⁻¹ to determine at least one property of the sample, the at least one property of the sample being selected from the group consisting of a concentration of at least one constituent in the sample, at least one characteristic of the sample, and any combination thereof.

### BACKGROUND

The present disclosure relates to spectroscopic measurements, and, more specifically, to spectral monitoring of samples having complex mixtures of constituents in a matrix therein.

Spectroscopic techniques can be an extremely powerful tool for conducting sample analyses, since they usually can provide chemical information more rapidly than is possible with standard laboratory analyses. Through judicious choice of a spectroscopic technique, one of ordinary skill in the art may determine multiple pieces of chemical information about a sample, such as its qualitative and quantitative chemical composition. By knowing the chemical composition of a sample, one can determine if the bulk substance from which the sample is obtained is suitable for its intended use. However, spectroscopic analyses of samples containing complex mixtures of constituents can sometimes be extremely complicated due to overlapping spectral signatures of the constituents and/or the sample matrix.

Subterranean operations are one area in which it can be desirable to analyze complex samples, such as the compositions and/or characteristics of substances that are introduced to and/or produced from a subterranean formation. Fluids, which may be introduced to or produced from a subterranean formation, are commonly encountered in subterranean operations and can oftentimes comprise complex mixtures of constituents.

Fluids can be used in a variety of subterranean operations to treat a subterranean formation. Fluids can also be used in a variety of operations to treat the interior of a vessel transporting or housing the fluid, such as a pipeline, for example. Accordingly, both such fluids will be referred to herein as “treatment fluids,” As used herein, the term “treatment fluid” refers to a fluid that is placed in a location in order to perform a desired function or to achieve a desired purpose. Treatment fluids can be used in a variety of subterranean operations including, but not limited to, drilling operations, production operations, stimulation operations, remediation operations, fluid diversion operations, secondary or tertiary enhanced oil recovery (EOR) operations, and the like. As used herein, the terms “treat,” “treatment,” “treating,” and other grammatical equivalents thereof refer to any operation that uses a fluid in conjunction with performing a desired function and/or achieving a desired purpose. The terms “treat,” “treatment,” and “treating,” as used herein, do not imply any particular action by the fluid or any particular constituent thereof unless otherwise specified. Treatment fluids can include, for example, drilling fluids, fracturing fluids, acidizing fluids, conformance treatment fluids, damage control fluids, remediation fluids, scale removal and inhibition fluids, biocidal fluids, chemical floods, and the like.

When conducting treatment operations within a subterranean formation, it can be beneficial to know the chemical and/or physical properties of a fluid being introduced into or produced from the formation. Similarly, it can also sometimes be desirable to analyze a surface within a subterranean formation to gather information relating to the formation itself. Because of their complex nature, analysis of samples encountered in subterranean operations can be technically challenging, as multiple analytical techniques may be needed to fully analyze for the constituents and sample characteristics of interest. Further complicating this issue, some of these analyses are not particularly well suited for being conducted in the field and/or require specialized equipment and operator training. In many cases, analyses are conducted in off-site laboratories and can take a period of hours to weeks to complete.

Fluids, in particular, may present a special set of challenges with regard to subterranean operations. While analysis of a fluid takes place, the fluid either has to be stored for subsequent introduction to the subterranean formation, or it has to be used blindly in a subterranean operation based on the presumption that it has acceptable properties. Neither case is ideal. Waiting on lengthy analyses may result in costly production delays. Furthermore, the properties and composition of the fluid may change over time (e.g., due to scaling, precipitation, chemical reaction of constituents with one another, chemical degradation, bacterial growth, environmental factors, and the like). On the other hand, introducing a fluid having unsuitable properties to a subterranean formation may result in an ineffective treatment operation and/or formation damage, both of which may result in delays and additional production cost. Factors that may make a fluid unsuitable for introduction to a given subterranean formation may include, for example, an incorrect concentration of a desired constituent, an incorrect constituent, an incorrect viscosity, an incorrect pH, an interfering impurity, an incorrect sag potential, an incorrect kind or concentration of proppant particulates, bacterial contamination, and/or the like. Similar issues may be encountered with fluids that are produced from a subterranean formation, where delayed analyses of the produced fluid are not representative of the fluid's true nature following production.

Although off-site analyses of a fluid can be satisfactory in certain instances, such analyses do not allow real-time or near real-time monitoring of the fluid to take place during a treatment operation, as noted above. Thus, off-site analyses do not offer the possibility for proactive control of a treatment operation to take place by modifying the properties of a treatment fluid with minimal production delays. Modifying the properties of a treatment fluid may make the fluid suitable for introduction to the subterranean formation. Alternately, by monitoring a fluid being produced from the subterranean formation, one can determine if a treatment fluid needs to be used in conjunction with production or if a treatment fluid is having a desired effect. In addition, produced fluids can provide valuable insight into the formation chemistry and contents if properly analyzed.

In spite of the wealth of chemical information that can be present in produced fluids, it has sometimes been conventional in the art to simply dispose of unwanted produced fluids, such as produced formation water and produced aqueous fluids (e.g., spent or partially spent treatment fluids). With increasingly stringent environmental regulations, it has become increasingly more difficult to dispose of water and other produced aqueous fluids. As a result, water treatment, conservation, and management are becoming ever more important in the oil and gas industry. Moreover, many treatment operations utilize considerable water volumes (e.g., millions of gallons to treat a single wellbore), and obtaining sufficient water of suitable quality to conduct a treatment operation may be problematic in certain instances and locations.

Despite the usual ready availability of produced aqueous fluids, it has not been conventional in the art to reuse these fluids for conducting subterranean treatment operations. Chemical incompatibilities in treatment fluids are commonly observed. As a result, some produced aqueous fluids may not be suitable for forming certain types of treatment fluids. This difficulty has often been exacerbated by the inability to readily analyze produced aqueous fluids rapidly and accurately in the field (e.g., in real-time or near real-time). Despite these issues, there remains considerable interest in the reintroduction of produced aqueous fluids to a subterranean formation, either for waste disposal purposes or for carrying out a subsequent treatment operation.

### SUMMARY

The present disclosure relates to spectroscopic measurements, and, more specifically, to spectral monitoring of samples having complex mixtures of constituents in a matrix therein.

In some embodiments, the present disclosure provides a method comprising: providing a sample comprising a matrix and one or more constituents therein; exposing the sample to electromagnetic radiation in a spectral region where the matrix optically interacts with the electromagnetic radiation, so as to acquire a spectrum of the matrix; and analyzing the spectrum of the matrix within a wavelength range where the matrix has a molar extinction coefficient of at least about 0.005 M⁻¹mm⁻¹ to determine at least one property of the sample, the at least one property of the sample being selected from the group consisting of a concentration of at least one constituent in the sample, at least one characteristic of the sample, and any combination thereof.

In some embodiments, the present disclosure provides a method comprising: providing a sample comprising a matrix and a plurality of constituents therein; exposing the sample to electromagnetic radiation in a spectral region where the matrix optically interacts with the electromagnetic radiation, so as to acquire a spectrum of the matrix; wherein the constituents are substantially spectroscopically inactive in the spectral region; and analyzing the spectrum of the matrix to determine at least one property of the sample, the at least one property of the sample being selected from the group consisting of a concentration of at least one constituent in the sample, at least one characteristic of the sample, and any combination thereof.

The features and advantages of the present invention will be readily apparent to one having ordinary skill in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 shows near-infrared absorption spectra for water at various cell path lengths.

FIGS. 2A and 2B show near-infrared absorption spectra for various ionic constituents in water.

FIGS. 3A-3D show regression vectors determined for chloride, sulfate, total boron, and total iron, respectively, over the wavelength range of 2000 nm to 2350 nm.

FIG. 4 shows a regression vector determined for specific gravity over the wavelength range of 1375 nm to 1900 nm.

FIG. 5 shows an aggregate near-infrared absorption spectrum of 27 field-produced water samples at a path length of 2 mm against a water reference.

FIG. 6 shows an aggregate near-infrared spectra absorption spectrum of 27 field-produced water samples at a path length of 2 mm against a water reference following normalization.

FIGS. 7A and 7B show expansions of the data of FIG. 6 following conversion into transmission mode.

FIGS. 8A-8D show illustrative calibration curves for chloride, sulfate, total boron, and total iron, respectively,

FIGS. 9A-9I show illustrative plots of predicted concentration, as determined by dot product analysis, compared to experimentally determined concentrations.

### DETAILED DESCRIPTION

The present disclosure relates to spectroscopic measurements, and, more specifically, to spectral monitoring of samples having complex mixtures of constituents in a matrix therein.

As discussed above, analyses of samples having mixtures of constituents therein may present difficulties that often necessitate the use of multiple analytical techniques. As used herein, the term “constituent” refers to a substance that is disposed within a matrix. As used herein, the term “matrix” refers to a continuous phase in which a constituent is disposed. Complex samples may be commonly encountered in the field of subterranean treatment operations or other types of treatment operations. For example, it can sometimes be desirable to know the composition and properties of a fluid being introduced into or produced from a subterranean formation. Such fluids can often comprise a complex mixture of constituents within a continuous fluid phase and heretofore have not been amenable to rapid analyses in or near the field, certainly not in real-time or near real-time. As used herein, the terms “real-time” and “near real-time” refer to a determination of a sample concentration or sample characteristic that takes place in the same time frame as the interrogation of the sample with electromagnetic radiation. That is, “real-time” or “near real-time” determinations do not take place offline after data sampling using post-acquisition processing techniques.

A further complication with fluids commonly encountered in subterranean treatment operations or other types of treatment operations is that a number of the constituents of interest are not considered to be spectroscopically active by routine spectroscopic techniques, such as infrared, visible, and ultraviolet spectroscopic methodologies. As used herein, the term “spectroscopically active” refers to a substance that optically interacts with electromagnetic radiation of a given wavelength or wavelength range. That is, a substance that is “spectroscopically active” results in a measurable change in a quantity of electromagnetic radiation optically interacting therewith. As used herein, the term “optically interact” and variants thereof refer to the reflection, transmission, scattering, diffraction, or absorption of electromagnetic radiation by a sample. In contrast, a substance that is “spectroscopically inactive” refers to a substance that does not substantially optically interact with electromagnetic radiation of a given wavelength or wavelength range. That is, a substance that is “spectroscopically inactive” does not measurably change or only negligibly changes electromagnetic radiation optically interacting therewith. Accordingly, a substance that is spectroscopically inactive cannot be classicly interrogated with electromagnetic radiation to produce a spectrum thereof. Common constituents that are spectroscopically inactive in the visible and infrared spectral regions of the electromagnetic spectrum include, for example, alkali metal ions such as sodium and potassium, as well as other metal ions. When spectroscopically inactive constituents are present, alternative chemical analyses (e.g., ion chromatography, volumetric analyses, or gravimetric analyses) can be employed, or dyes can sometimes be added to produce a spectroscopically active species. Metal ions can also be detected by techniques such as atomic absorption spectroscopy (AAS) or atomic emission spectroscopy (AES), which can include inductively coupled plasma (ICP) spectroscopy. In most cases, involved sample preparation techniques can sometimes be needed to achieve a satisfactory analytical result. In any event, the analyses are generally not able to be conducted rapidly, or in the field, certainly not in real-time or near real-time.

In most conventional spectroscopic analyses, it is typical to analyze for constituents of a matrix in a spectral region where the matrix itself is not spectroscopically active. For example, conventional spectroscopic analyses of a fluid phase are usually performed by analyzing a spectral region where a fluid phase constituent of interest is spectroscopically active and the fluid phase is spectroscopically inactive or substantially spectroscopically inactive, so as not to obscure spectral features associated with the constituent. That is, conventional spectroscopic analyses usually rely upon the constituent of interest optically interacting with electromagnetic radiation more strongly than the fluid phase in which it is disposed. In the alternative, sample preparation techniques may be used to at least partially separate a constituent from its matrix so as to be able to separately analyze each.

In contrast to most conventional spectroscopic analyses, we have surprisingly discovered that various constituents of a matrix may be determined spectroscopically, not by direct spectroscopic determination of the constituent itself (i.e., through analyzing a spectral feature associated with the constituent), but by analyzing the spectral features of the matrix. More specifically, we have discovered that a plurality of constituents within a fluid phase can influence its spectrum to differing degrees, even at very low concentration levels. These slight perturbations carry a wealth of chemical and physical property information, which may be extracted from the spectrum using regression vectors developed from a training set of data for standards having known compositions and properties. The regression vectors may be predictive for determining the composition and properties of a sample. Further discussion regarding the creation of regression vectors and using the regression vectors in spectral analyses is described in greater detail hereinafter.

Moreover, we have discovered that concentrations of two or more constituents within a matrix can be determined from a single spectrum of the matrix. That is, two or more constituents may be analyzed simultaneously in the presence of one another using the regression vector for each. Furthermore, different regions of the matrix spectrum need not necessarily be analyzed for each constituent. That is, the wavelength range analyzed for one constituent may overlap the wavelength range analyzed for another constituent due to the unique way in which the constituents each perturb the matrix spectrum in linear or non-linear combinations with one another. Conventional spectroscopic analyses, in contrast, ideally seek to utilize well separated spectral features when analyzing two or more constituents so that the constituents can be analyzed essentially independently of one another (i.e., so that their absorption peaks do not overlap). This can present considerable analytical difficulties when broad spectral features or a large number of constituents are present.

Due to the difficulties associated with interfering constituents, an even more preferred technique in conventional spectroscopy is to separate and analyze the constituents within a matrix individually, such that there is a reduced likelihood of unwanted interference taking place. Although this approach can be successfully used when analyzing mixtures, it can considerably add to the time, expense, and complexity of an analysis. Furthermore, some constituents may not be readily separable from one another or from the matrix. Although separation methodologies may be used in conjunction with the techniques described herein, there is no general necessity to do so, in this regard, the techniques described herein are especially advantageous in their simplicity, particularly in their ability to readily analyze mixtures of constituents within matrix, particularly a fluid phase.

Even more surprisingly, we have also discovered that at least some physical and chemical properties of a fluid phase may have a regression vector associated therewith and may be determined spectroscopically, even when the physical or chemical property itself is not conventionally thought to be spectroscopic in nature. As used herein, the term “characteristic” will be used to refer to the value of a physical or chemical property. Characteristics such as, for example, pH, total dissolved solids, ionic strength, and specific gravity may be determined spectroscopically according to the techniques described herein. It is anticipated that characteristics such as, for example, total suspended solids, viscosity, opacity, and yield point may be determined in a like manner. These results are completely surprising and unexpected, since such quantities are non-spectroscopic in nature. Accordingly, the presently described techniques are further advantageous from the standpoint of presenting a spectroscopic alternative to conventional non-spectroscopic analytical techniques.

Thus, the techniques described herein may be advantageous in terms of their simplicity and their ability to simultaneously analyze multiple constituents within a matrix, particularly a fluid phase. Moreover, we believe that the techniques are extendable to many different types of fluid phases, as well as non-fluid matrices. In regard to subterranean treatment operations or other types of treatment operations, the techniques described herein may allow the treatment operations to be conducted more rapidly, at lower cost, and with greater confidence of a treatment fluid's suitability for a given application than would otherwise be possible. The techniques may also allow a treatment fluid to be modified prior to or during its introduction to a subterranean formation in order to make the treatment fluid more suitable for use therein. In some cases, a treatment fluid may be monitored and modified after being introduced to a location. For example, a treatment fluid being stored in a vessel or introduced to a pipeline may be modified in some manner after introduction thereto, if desired.

In further regard to the analysis of treatment fluids, in some embodiments, the techniques described herein may allow produced aqueous fluids (e.g., produced water, spent or partially spent aqueous treatment fluids, or any combination thereof) to be analyzed for determining their suitability for use in subsequent treatment operations. For example, a produced aqueous fluid having suitable properties may be used as the carrier fluid of a treatment fluid to be introduced into the subterranean formation that produced the aqueous fluid or a different subterranean formation. Although the constituents of any type of treatment fluid may be analyzed by the techniques described herein, it may be particularly advantageous to analyze the constituents and properties of fracturing fluids and acidizing fluids, since these types of treatment fluids are particularly susceptible to incompatibilities. Given the analysis of a produced aqueous fluid, one of ordinary skill in the art will be able to determine the suitability of the fluid for reuse as the carrier fluid in a particular treatment fluid. Further, one of ordinary skill in the art will be able to recognize ways to modify a produced aqueous fluid in order to improve its suitability for use as the carrier fluid in a particular type of treatment fluid. Thus, by modifying a produced aqueous fluid, treatment fluids having custom formulations designed to meet the particular features of the produced aqueous fluid may be developed. Accordingly, the techniques described herein may advantageously allow water management issues that are commonly encountered in subterranean treatment operations to be better addressed.

In regard to fracturing fluids, and without being bound by any theory or mechanism, it is believed that certain ionic materials may be detrimental for a number of different reasons. For example, sodium and potassium ions may affect the hydration state of polymers. Other ions such as, for example, borate, iron, sodium, and aluminum may compete for crosslinking sites. In certain cases, pH control of some aqueous fluids may be problematic. All of these factors may influence the overall rheological properties and ultimate performance of a fracturing fluid. Likewise, in an acidizing fluid, the presence of certain ions may lead to a less effective acidizing treatment or unwanted precipitation damage.

Although the foregoing has described the particular advantages associated with the presently described techniques in regard to treatment fluids, it is to be recognized that the techniques may be applicable to other industries, particularly those in which it is desirable to analyze a substance in real-time or near real-time. Illustrative but non-limiting industries may include the food and drug industry, the petrochemical industry, the water treatment industry, the waste recycling industry, the cosmetic industry, and the like. Moreover, although the description herein is primarily directed to analyses of fluid phases having various constituents therein, it is to be understood that it is believed that the described techniques may be extended to analyses of constituents within solid samples as well.

In some embodiments, methods described herein can comprise: providing a sample comprising a matrix and one or more constituents therein; exposing the sample to electromagnetic radiation in a spectral region where the matrix optically interacts with the electromagnetic radiation, so as to acquire a spectrum of the matrix; and analyzing the spectrum of the matrix within a wavelength range where the matrix has a molar extinction coefficient of at least about 0.005 M⁻¹ mm⁻¹ to determine at least one property of the sample, the at least one property of the sample being selected from the group consisting of a concentration of at least one constituent in the sample, at least one characteristic of the sample, and any combination thereof.

In some embodiments, methods described herein can comprise: providing a sample comprising a matrix and one or more constituents therein; exposing the sample to electromagnetic radiation in a spectral region where the matrix optically interacts with the electromagnetic radiation, so as to acquire a spectrum of the matrix; wherein the constituents are substantially optically inactive in the spectral region; and analyzing the spectrum of the matrix to determine at least one property of the sample, the at least one property of the sample being selected from the group consisting of a concentration of at least one constituent in the sample, at least one characteristic of the sample, and any combination thereof.

In general, but without being bound by theory or mechanism, it is believed that the one or more constituents perturb the spectrum of the matrix in the sample relative to a spectrum of the matrix alone. Specifically, it is believed that the spectrum of the matrix is perturbed in a linear or non-linear combinatorial manner based on a contribution from each constituent. In some embodiments, the matrix may comprise a fluid phase. As used herein, the term “fluid phase” refers to any substance that is capable of flowing, including particulate solids, liquids, gases, slurries, emulsions, powders, muds, glasses, any combination thereof, and the like. In some embodiments, the matrix may comprise a non-fluid phase, such as a solid.

In some embodiments, methods described herein can comprise: providing a treatment fluid comprising a fluid phase and one or more constituents therein; exposing the treatment fluid to electromagnetic radiation in a spectral region where the fluid phase optically interacts with the electromagnetic radiation, so as to acquire a spectrum of the fluid phase; analyzing the spectrum of the fluid phase to determine at least one property of the treatment fluid, the at least one property of the treatment fluid being selected from the group consisting of a concentration of at least one constituent in the treatment fluid, at least one characteristic of the treatment fluid, and any combination thereof; and introducing the treatment fluid into a subterranean formation.

In some embodiments, methods described herein can comprise: providing a fluid phase containing one or more constituents therein; exposing the fluid phase to electromagnetic radiation in a spectral region where the fluid phase optically interacts with the electromagnetic radiation, so as to acquire a spectrum of the fluid phase; analyzing the spectrum of the fluid phase to determine at least one property thereof, the at least one property of the fluid phase being selected from the group consisting of a concentration of at least one constituent in the fluid phase, at least one characteristic of the fluid phase, and any combination thereof; determining if the at least one property is in a desired range; and introducing the fluid phase into a vessel. In some embodiments, the vessel may comprise a storage tank or a pipeline, for example.

In some embodiments, the fluid phase may comprise an aqueous fluid. In some embodiments, the fluid phase may comprise water. Water sources may include, for example, fresh water, acidified water, salt water, seawater, brine, aqueous salt solutions, surface water (i.e., streams, rivers, ponds and lakes), underground water from an aquifer, municipal water, municipal waste water, or produced water. In some embodiments, the fluid phase may comprise a produced aqueous fluid. Produced aqueous fluids may comprise produced water, formation water, spent aqueous treatment fluids, partially spent aqueous treatment fluids, and any combination thereof. As used herein, the term “formation water” refers to water that is natively present in a subterranean formation and is expelled from the formation in the course of production. As used herein, the term “produced water” refers to water that is present in a subterranean formation, regardless of its source, and is expelled from the formation in the course of production. As used herein, the terms “spent aqueous treatment fluid” and “partially spent aqueous treatment fluid” refer to treatment fluids comprising an aqueous carrier fluid that are wholly or partially depleted of their active constituent and are expelled from the formation in the course of production. In addition, spent or partially spent aqueous treatment fluids may comprise produced aqueous fluids that are measurably changed in a characteristic, even though their bulk composition may be substantially the same. For example, a produced aqueous fluid may comprise a broken fracturing fluid that is no longer in a viscosified state, although the viscosified state and the broken state may not differ significantly in composition from one another.

In some or other embodiments, the fluid phase may comprise an oleaginous fluid such as oil or a like produced hydrocarbon, for example. In some embodiments, the oleaginous fluid being analyzed may comprise a drilling mud. In some embodiments, the fluid phase may comprise a mixture of an aqueous fluid and an oleaginous fluid.

In some embodiments, the methods may further comprise determining a regression vector for each constituent in the sample or each characteristic of the sample being analyzed. Determination of the regression vector may allow a concentration of the constituent in the sample or the value of a sample characteristic to be spectroscopically calculated. The regression vector for each constituent or characteristic may be determined using standard procedures that will be familiar to one having ordinary skill in the art. A brief summary of these procedures is provided below. In various embodiments, analyzing the spectrum of the matrix may comprise determining a dot product of the regression vector for each constituent in the sample or characteristic of the sample being analyzed. As one of ordinary skill in the art will recognize, a dot product of a vector is a scalar quantity (i.e., a real number). While the dot product value is believed to have no physical meaning by itself (it may be positive or negative and of any magnitude), comparison of the dot product value of a sample with dot product values obtained for known reference standards and plotted in a calibration curve may allow the sample dot product value to be correlated with a concentration or value of a characteristic, thereby allowing unknown samples to be analyzed. To determine the dot product, one simply multiplies the regression coefficient of the regression vector at a given wavelength times the spectral intensity at the same wavelength. This process is repeated for all wavelengths analyzed, and the products are summed over the entire wavelength range to yield the dot product. More importantly, the techniques described herein may allow two or more properties of a sample to be determined from a single spectrum of the matrix by applying a regression vector for each constituent or characteristic.

Further details regarding the determination of a regression vector and its use in determining a dot product are now provided. It is possible to derive information from electromagnetic radiation interacting with a sample by, for example, separating the electromagnetic radiation from several samples into wavelength bands and performing a multiple linear regression of the band intensity against a constituent concentration or characteristic determined by another measurement technique for each sample. The measured concentration or characteristic may be expressed and modeled by multiple linear regression techniques that will be familiar to one having ordinary skill in the art. Specifically, if y is the measured value of the concentration or characteristic, y may be expressed as in Formula 1,

y=a₀+a₁w₁+a₂w₂+a₃w₃+a₄w₄+ . . . . (Formula 1)

where each a is a constant determined by the regression analysis and each w is the light intensity for each wavelength band. Depending on the circumstances, the estimate obtained from Formula 1 may be inaccurate, for example, due to the presence of other constituents within the sample that may affect the intensity of the wavelength bands.

A more accurate estimate may be obtained by expressing the electromagnetic radiation in terms of its principal components. To obtain the principal components, spectroscopic data is collected for a variety of similar samples using the same type of electromagnetic radiation. For example, following exposure to each sample, the electromagnetic radiation may be collected and the spectral intensity at each wavelength may be measured for each sample. This data may then be pooled and subjected to a linear-algebraic process known as singular value decomposition (SVD) in order to determine the principal components. Use of SVD in principal component analysis will be well understood by one having ordinary skill in the art. Briefly, principal component analysis is a dimension reduction technique, which takes m spectra with n independent variables and constructs a new set of eigenvectors that are linear combinations of the original variables. The eigenvectors may be considered a new set of plotting axes. The primary axis, termed the first principal component, is the vector that describes most of the data variability. Subsequent principal components describe successively less sample variability, until the higher order principal components essentially describe only spectral noise. Use of too few principal components may provide an inaccurate estimate, whereas use of too many principal components may unduly model spectral noise. In various embodiments described herein, we have found that use of about 4 to about 6 principal components provides sufficient accuracy without unduly modeling spectral noise.

As used herein, the term “accuracy” refers to the extent to which a determined value of a concentration or characteristic represents the true value. As used herein, the term “precision” refers to the reproducibility of a result.

Typically, the principal components are determined as normalized vectors. Thus, each component of an electromagnetic radiation sample may be expressed as xₙzₙ, where xₙ is a scalar multiplier and zₙ is the normalized component vector for the nₜₕ component. That is, zₙ, is a vector in a multi-dimensional space where each wavelength is a dimension. As will be understood by one having ordinary skill in the art, normalization determines values for a component at each wavelength so that the component maintains its shape and the length of the principal component vector is equal to one. Thus, each normalized component vector has a shape and a magnitude so that the components may be used as the basic building blocks of any electromagnetic radiation sample having those principal components. Accordingly, each electromagnetic radiation sample may be described by a combination of the normalized principal components multiplied by the appropriate scalar multipliers, as set forth in Formula 2.

x₁z₁+x₂z₂+ . . . +xₙzₙ (Formula 2)

The scalar multipliers xₙ may be considered the “magnitudes” of the principal components in a given electromagnetic radiation sample when the principal components are understood to have a standardized magnitude as provided by normalization.

Because the principal components are orthogonal, they may be used in a relatively straightforward mathematical procedure to decompose an electromagnetic radiation sample into the component magnitudes, which may accurately describe the data in the original electromagnetic radiation sample. Since the original electromagnetic radiation sample may also be considered a vector in the multi-dimensional wavelength space, the dot product of the original signal vector with a principal component vector is the magnitude of the original signal in the direction of the normalized component vector. That is, it is the magnitude of the normalized principal component present in the original signal. This is analogous to breaking a vector in a three dimensional Cartesian space into its X, Y and Z components. The dot product of the three-dimensional vector with each axis vector, assuming each axis vector has a magnitude of 1, gives the magnitude of the three dimensional vector in each of the three directions. The dot product of the original signal and some other vector that is not perpendicular to the other three dimensions provides redundant data, since this magnitude is already contributed by two or more of the orthogonal axes.

Because the principal components are orthogonal (i.e., perpendicular) to each other, the dot product of any principal component with any other principal component is zero. Physically, this means that the components do not interfere with each other. If data is altered to change the magnitude of one component in the original electromagnetic radiation signal, the other components remain unchanged. In the analogous Cartesian example, reduction of the X component of the three dimensional vector does not affect the magnitudes of the Y and Z components.

Principal component analysis provides the fewest orthogonal components that can accurately describe the data carried by the electromagnetic radiation samples. Thus, in a mathematical sense, the principal components are components of the original electromagnetic radiation that do not interfere with each other and that represent the most compact description of the spectral signal. Physically, each principal component is an electromagnetic radiation signal that forms a part of the original electromagnetic radiation signal. Each principal component has a shape over some wavelength range within the original wavelength range. Summing the principal components may produce the original signal, provided each component has the proper magnitude.

The principal components may comprise a compression of the information carried by the total light signal. In a physical sense, the shape and wavelength range of the principal components describe what information is in the total electromagnetic radiation signal, and the magnitude of each component describes how much of that information is present. If several electromagnetic radiation samples contain the same types of information, but in differing amounts, then a single set of principal components may be used to describe (except for noise) each electromagnetic radiation sample by applying appropriate magnitudes to the components. The principal components may be used to provide an estimate of a concentration or characteristic of a sample based upon the information carried by electromagnetic radiation that has interacted with that sample. Differences observed in spectra of samples having varying quantities of a constituent or values of a characteristic may be described as differences in the magnitudes of the principal components. Thus, the concentration of a constituent or value of a characteristic may be expressed by the principal components according to Formula 3 in the case where 4 principal components are used,

y=a₀+a₁x₁+a₂x₂+a₃x₃+a₄x₄ (Formula 3)

where y is a concentration of a constituent or value of a characteristic, each a is a constant determined by the regression analysis, and x₁, x₂, x₃ and x₄ are the first, second, third, and fourth principal component magnitudes, respectively. Formula 3 may be referred to as a regression vector. The regression vector may be used to provide an estimate for the concentration of a constituent or a value of a characteristic for an unknown sample.

Regression vector calculations may be performed by computer, based on spectrometer measurements of electromagnetic radiation by wavelength. The spectrometer system spreads the electromagnetic radiation into its spectrum and measures the spectral intensity at each wavelength over the wavelength range. Using Formula 3, the computer may read the intensity data and decompose the electromagnetic radiation sample into the principal component magnitudes xₙ by determining the dot product of the total signal with each component. The component magnitudes are then applied to the regression equation to determine a concentration or value of a characteristic.

To simplify the foregoing procedure, however, the regression vector may be converted to a form that is a function of wavelength so that only one dot product is determined. Each normalized principal component vector zₙ has a value over all or part of the total wavelength range. If each wavelength value of each component vector is multiplied by the regression constant aₙ corresponding to the component vector, and if the resulting weighted principal components are summed by wavelength, the regression vector takes the form of Formula 4,

y=a₀+b₁u₁+b₂u₂+ . . . +bₙuₙ (Formula 4)

where a₀ is the first regression constant from Formula 3, bₙ is the sum of the multiple of each regression constant aₙ from Formula 3 and the value of its respective normalized regression vector at wavelength n, and uₙ is the intensity of the electromagnetic radiation at wavelength n. Thus, the new constants define a vector in wavelength space that directly describes a concentration or characteristic of a sample. The regression vector in the form of Formula 4 represents the dot product of an electromagnetic radiation sample with this vector.

Normalization of the principal components provides the components with an arbitrary value for use during the regression analysis. Accordingly, it is very unlikely that the dot product value produced by the regression vector will be equal to the actual concentration or characteristic value of a sample being analyzed. The dot product result is, however, a function of the concentration or characteristic value. As discussed above, the function may be determined by measuring one or more known calibration samples by conventional means and comparing the result to the dot product value of the regression vector. Thereafter, the dot product result can be compared to the value obtained from the calibration standards in order to determine the concentration or characteristic of an unknown sample being analyzed. The function relating the dot product to the concentration or characteristic may be of any type including, for example, linear functions, quadratic functions, polynomial functions, logarithmic functions, exponential functions, and the like.

In some embodiments, principal component analysis techniques may include partial least squares analysis, for example. The principal component analysis may be conducted using standard statistical analysis software packages including, for example, XL Stat for MICROSOFT® EXCEL®, the UNSCRAMBLER® from CAMO Software, and MATLAB® from MATHWORKS®.

In various embodiments, determination of a regression vector and calculation of a dot product may take place under computer control or other types of automated processing means. Further, as described below, in some embodiments, a fluid may be modified to change one or more concentrations or characteristics thereof. Such processes may also take place under computer control, optionally using an artificial neural network.

It is to be recognized that in the various embodiments herein that take place under computer control or other automated processing means, various blocks, modules, elements, components, methods, and algorithms can be implemented through using computer hardware, software and combinations thereof. To illustrate this interchangeability of hardware and software, various illustrative blocks, modules, elements, components, methods and algorithms have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application. Further, various components and blocks can be arranged in a different order or partitioned differently, for example, without departing from the spirit and scope of the embodiments expressly described.

Computer hardware used to implement the various illustrative blocks, modules, elements, components, methods and algorithms described herein can include a processor configured to execute one or more sequences of instructions, programming, or code stored on a readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network or any like suitable entity that can perform calculations or other manipulations of data. In some embodiments, computer hardware can further include elements such as, for example, a memory [e.g., random access memory (RAM), flash memory, read only memory (ROM), programmable read only memory (PROM), erasable PROM], registers, hard disks, removable disks, CD-ROMs, DVDs, or any other like suitable storage device.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

Various constituents may be present within a matrix, particularly a fluid phase, and measurable through the techniques described herein. In various embodiments, constituents within a matrix that may be analyzed include, for example, organic compounds (e.g., alcohols, carboxylic acids, amines, surfactants, polymers, biopolymers, sugars, biomolecules, and the like), inorganic compounds (e.g., salts, coordination compounds, organometallic compounds, and the like), bacteria and other microorganisms, and the like. As described hereinafter, constituents being analyzed in the matrix are not believed to be particularly limited as long as a suitable regression vector can be formulated for each constituent. In some embodiments, the constituent(s) within the matrix may comprise at least one ionic material. In some embodiments, the constituent(s) within the matrix may comprise a neutral substance.

Illustrative ionic materials that may be analyzed by the techniques described herein include both cations and anions. Cations and anions that may be analyzed include, for example, metal ions, non-metal ions, complex ions, monatomic ions, diatomic ions, triatomic ions, and polyatomic ions. In some embodiments, organic cations such as, for example, quaternary ammonium ions or amine salts may be analyzed by the techniques described herein. In some embodiments, organic anions such as, for example, carboxylates, phenoxides, organic phosphates, organic phosphonates, organic phosphinates, organic sulfates, organic sulfinates, and organic thiolates may be analyzed by the techniques described herein. In some embodiments, inorganic ions may be analyzed by the techniques described herein. In some embodiments, inorganic cations such as, for example, alkali metal ions, alkaline earth metal ions, transition metal ions, lanthanide ions, main group metal ions, complex metal ions, and the like may be analyzed and their concentration(s) determined. Illustrative metal ions that may be analyzed include, for example, sodium-containing ions, potassium-containing ions, strontium-containing ions, magnesium-containing ions, calcium-containing ions, barium-containing ions, and aluminum-containing ions. In some embodiments, inorganic anions may be analyzed and their concentration(s) determined. Illustrative inorganic anions that may be analyzed include, for example, carbon-containing ions (e.g., carbonate and bicarbonate), sulfur-containing ions (e.g., sulfate, sulfite, and sulfide), halogen-containing ions (e.g., fluoride, chloride, chlorate, chlorite, hypochlorite, bromide, bromate, iodide, iodate, periodate, and triiodide) and boron-containing ions (e.g., borate). Some of the foregoing cations and anions are of interest in the analysis of fracturing fluids, since their presence may impact the suitability of a fracturing fluid for conducting a fracturing operation. Other cations and anions that may be of interest for analysis in fracturing operations and other subterranean treatment operations may include, for example, manganese-containing ions, lithium-containing ions, cesium-containing ions, chromium-containing ions, arsenic-containing ions, lead-containing ions, mercury-containing ions, nickel-containing ions, copper-containing ions, zinc-containing ions, and titanium-containing ions. It is to be recognized that the foregoing lists of cations and anions are meant to be illustrative in nature and non-limiting. Moreover, one of ordinary skill in the art will be able to determine suitable cations and anions to be analyzed to determine the suitability of a substance for a given application. As discussed above, any cation or anion may be analyzed by the techniques described herein if a suitable regression vector can be determined to describe its concentration in a particular fluid phase.

In some embodiments, at least some of the constituent(s) within the matrix may be substantially spectroscopically inactive within the spectral region being analyzed. In other embodiments, at least some of the constituent(s) may be at least somewhat spectroscopically active within the spectral region being analyzed. For example, at least some of the constituent(s) may absorb electromagnetic radiation within the spectral region being analyzed. When a constituent absorbs at least some electromagnetic radiation, it may absorb at substantially the same wavelengths as the matrix or at substantially different wavelengths than the matrix.

In various embodiments of the methods described herein, the matrix may be spectroscopically active in the spectral region being analyzed. That is, there may be a “peak” or like spectral feature resulting from the optical interaction of electromagnetic radiation with the matrix. In some embodiments of the present methods, a spectroscopically active matrix may have a molar extinction coefficient of at least about 0.001 M⁻¹ mm⁻¹ associated therewith. As one of ordinary skill in the art will recognize, the molar extinction coefficient, ε, of a substance at a given wavelength is described by Beer's Law according to Formula 5, where I is the

ε=I/(cL) (Formula 5)

measured spectral intensity at a given wavelength in units of optical density, c is the concentration in molarity, and L is the path length (typically in mm or cm) over which the optical interaction takes place. In some embodiments, the matrix may have a molar extinction coefficient of at least about 0.002 M⁻¹mm⁻¹, or at least about 0.003 M⁻¹ mm⁻¹, or at least about 0.004 M⁻¹mm⁻¹, or at least about 0.005 M⁻¹mm⁻¹, or at least about 0.006 M⁻¹mm⁻¹, or at least about 0.007 M⁻¹mm⁻¹, or at least about 0.008 M⁻¹mm⁻, or at least about 0.009 M⁻¹mm⁻¹, or at least about 0.01 M⁻¹mm⁻¹, or at least about 0.015 M⁻¹ mm⁻¹, or at least about 0.02 M⁻¹mm⁻¹, or at least about 0.025 M⁻¹ mm⁻¹, or at least about 0.03 M⁻¹mm⁻¹, or at least about 0.035 M⁻¹ mm⁻¹, or at least about 0.04 M⁻¹mm⁻¹, or at least about 0.045 M⁻¹mm⁻¹, or at least about 0.05 M⁻¹mm⁻¹, or at least about 0.055 M⁻¹mm⁻¹, or at least about 0.06 M⁻¹mm⁻¹, or at least about 0.065 M⁻¹mm⁻¹, or at least about 0.07 M⁻¹mm⁻¹, or at least about 0.075 M⁻¹ mm⁻¹, or at least about 0.08 M⁻¹mm⁻¹, or at least about 0.085 M⁻¹mm⁻¹, or at least about 0.09 M⁻¹mm⁻¹, or at least about 0.095 M⁻¹mm⁻¹, or at least about 0.1 M⁻¹ mm⁻¹.

In addition to being capable of determining the concentration or form of various constituents within the matrix, the techniques described herein may be used to quantify at least some characteristics of the matrix. As described above, certain characteristics of a matrix, particularly a fluid phase, are not conventionally believed to be derivable by a spectral analysis. In some embodiments, characteristics that may be determined by the techniques described herein include, for example, pH, total dissolved solids, ionic strength, specific gravity, and any combination thereof. Other characteristics that are believed to be analyzable may include, for example, opacity, viscosity, total suspended solids, and yield point. In some embodiments, bacteria or like microorganisms are believed to be analyzable by the techniques described herein.

The techniques described herein may be applicable to any region of the electromagnetic spectrum in which the matrix optically interacts with electromagnetic radiation. Illustrative electromagnetic spectral regions that may be utilized for analysis of constituent concentrations or fluid phase characteristics may include, for example, the infrared (λ=1 mm to 750 nm), visible (λ=750 nm to 400 nm), and ultraviolet (λ=400 nm to 10 nm) regions of the electromagnetic spectrum. In more specific embodiments, the spectral region may comprise the near-infrared (λ=2500 nm to 750 nm) and/or the mid-infrared (λ=20000 nm to 2500 nm) regions of the electromagnetic spectrum. In still other embodiments, the spectral region may comprise the near-ultraviolet (λ=400 nm to 300 nm) and/or middle-ultraviolet (λ=300 nm to 200 nm) regions of the electromagnetic spectrum. Choice of the spectral region for analysis may be determined by the identity of the matrix and the constituents being analyzed. For example, in some embodiments, the spectral region may be chosen such that the matrix is spectroscopically active, while the constituent(s) are spectroscopically inactive. In other embodiments, the spectral region may be chosen such that the matrix and at least some of the constituent(s) are spectroscopically active.

in some embodiments, the spectral region being analyzed may lie within a wavelength range of about 1000 nm to about 25000 nm. In some or other embodiments, the spectral region being analyzed may lie within a wavelength range of about 2000 nm to about 25000 nm. In still other embodiments, the spectral region being analyzed may lie within a wavelength range of about 2000 nm and about 2000 nm.

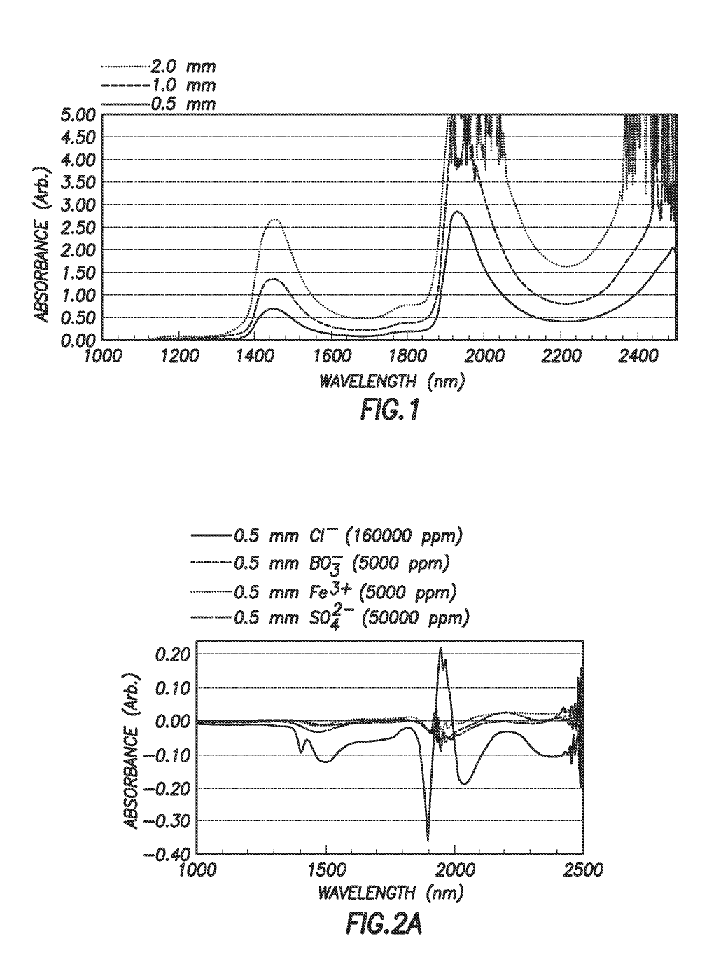

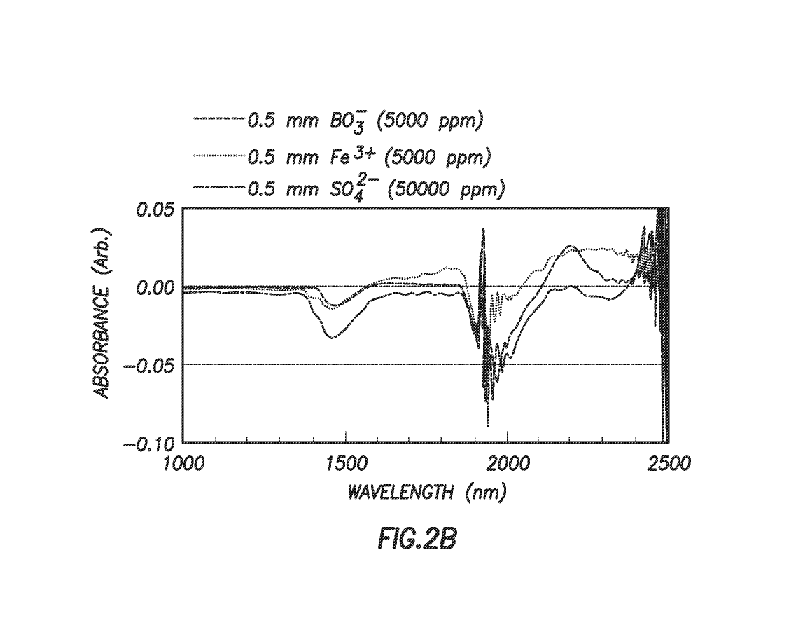

The near-infrared region of the electromagnetic spectrum may be particularly useful for analyzing aqueous fluids by the present techniques. As one of ordinary skill in the art will recognize, the spectral transitions associated with the infrared region may be related to rotational and/or vibrational transitions, including vibrational overtones and combinations thereof, which may be well suited for assaying the O—H bond in water. As one of ordinary skill in the art will further recognize, many commonly encountered fluid constituents, including many inorganic ions, are conventionally thought to be substantially optically inactive in this spectral region. Water, in contrast, has strong absorption bands in this spectral region. FIG. 1 shows near-infrared absorption spectra for water at various cell path lengths. The spectra are referenced against air. As can be seen from the spectra, pristine water shows strong near-infrared absorption bands between approximately 1360 nm-1600 nm, 1840 nm-2160 nm, and >2280 nm. Without being bound by any theory or mechanism, it is believed that these absorptions may be due to various water O—H bond vibrations, vibrational overtones, or combinations thereof. In the latter two regions, the peak absorbance is greater than 2 absorbance units, even for a 0.5 mm path length. FIGS. 2A and 2B show near-infrared absorption spectra for various ionic constituents in water. The spectra are measured relative to a water reference at path length of 0.5 mm. As can be seen from FIG. 2A, the presence of chloride, sulfate, borate, and iron (Fe³⁺) ions results in slight deviations of the near-infrared absorption spectrum when referenced against a pristine water background, with chloride producing the most significant and distinct deviations. FIG. 2B shows the absorption spectra of FIG. 2A with the chloride spectrum omitted so that the spectral details of the remaining ions may be more clearly seen. As can be seen from FIGS. 2A and 2B, subtle differences exist between the various ionic constituents. Given the location of the spectral absorbances of the ionic constituents and without being bound by any theory or mechanism, it is presumed that the constituents perturb the absorption spectrum of the water rather than directly absorbing electromagnetic radiation themselves. According to conventional theory in the spectroscopic arts, the ionic constituents of FIGS. 2A and 2B would be presumed to be optically inactive in the near-infrared spectral region. Indeed, the small spectral perturbations induced by the constituents could easily be lost without careful analysis of the fluid phase, particularly when analyzing an intense spectral interaction associated with the fluid phase. However, as demonstrated herein, these weak spectral perturbations may be used to extract a wealth of chemical information from a single spectrum.

It is to be recognized that the spectral features observable by the present methods are not thought to be limited to those associated with the O—H bond in water. Other types of fluids may also be analyzed by the techniques described herein, and other spectral regions may be used for the analysis, if necessary. For example, when analyzing a matrix comprising an oleaginous fluid, other types of bonds may be analyzed including, for example, C—H, C—O, C═O, C—X (X=halogen), C—N, N—H, S═O, and S—O. In some embodiments, oleaginous fluids having these types of bonds may be analyzed using the mid-infrared spectral region. In some embodiments, a drilling mud comprising an oleaginous fluid or a mixture of an oleaginous fluid and an aqueous fluid may be analyzed by the techniques described herein.

In various embodiments, the techniques described herein may be applied to samples using conventional, commercially available spectrophotometers. This represents another advantage of the present techniques, since custom-built equipment is not necessarily required in order to practice the techniques. Any suitable type of optical interaction of electromagnetic radiation with the sample can be employed including, for example, absorption, transmission, reflection, dispersion, and the like. Depending on the type of sample, one of ordinary skill in the art will be able to determine a suitable type of optical interaction upon which to conduct an analysis. For example, reflection techniques may be more appropriate for opaque samples in some cases. In some embodiments, the techniques described herein may be applied to a static fluid phase. For example, a sample comprising a fluid phase may be removed from its source and analyzed in a sample container within a standard spectrophotometer (e.g., at or near a job site, such as in a field laboratory). In some or other embodiments, the analysis may take place without removing the sample from the bulk material. That is, in some embodiments, the analysis may take place in situ. In some embodiments, the techniques described herein may be applied to a fluid phase that is in motion. For example, in some embodiments, the spectrum of a fluid phase may be obtained while a sample is flowing through the spectrometer. In such embodiments, an optically transparent fluid conduit containing the sample may be routed through the spectrometer such that the analysis may take place. Analysis of a flowing fluid phase may allow near real-time analysis of the fluid composition and properties to take place. In still other embodiments, a solid may be analyzed by the techniques described herein.

In some embodiments, analyzing the spectrum of the matrix may take place in real-time or near real-time. A result that is returned in “real-time” may be returned essentially instantaneously. A “near real-time” result may be returned after a brief delay, which may be associated with processing time, further data acquisition for determining a concentration or characteristic, and the like. It will be appreciated by one having ordinary skill in the art that the rate at which a sample concentration or sample characteristic is determined in “real-time” or “near real-time” may be dependent upon the rate at which processing takes place.

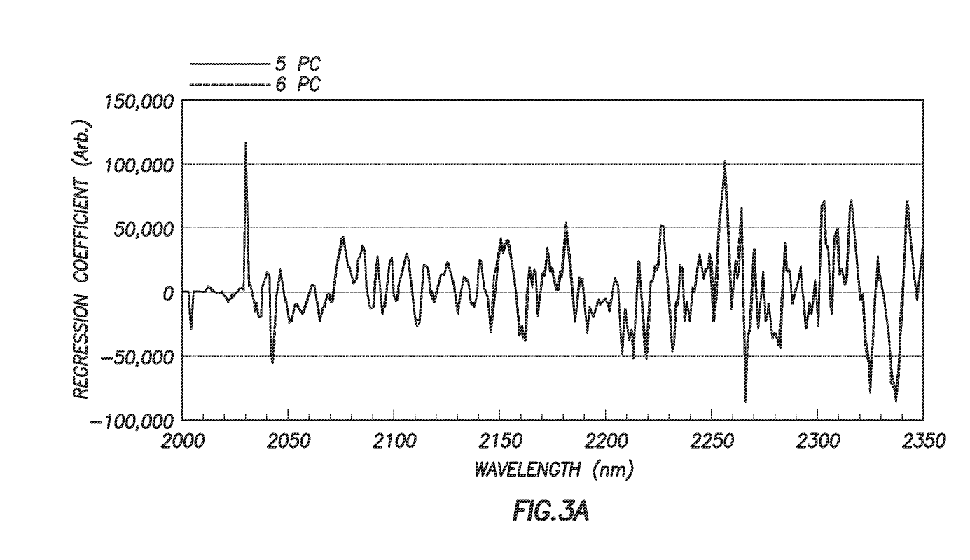

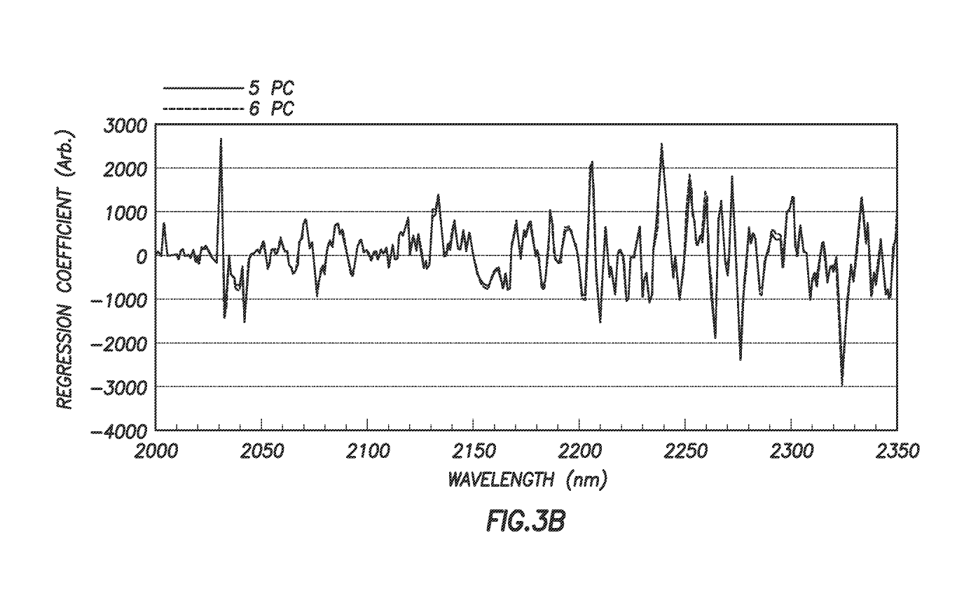

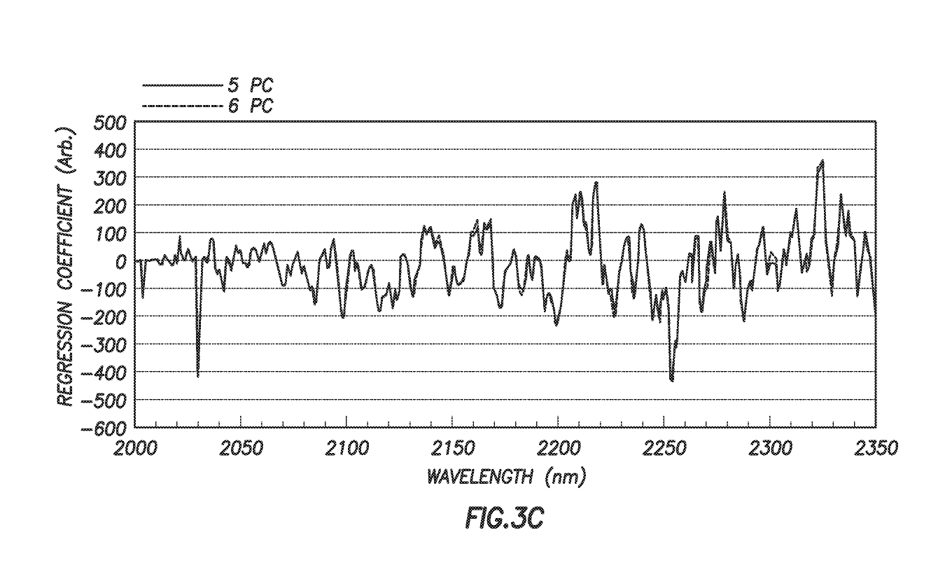

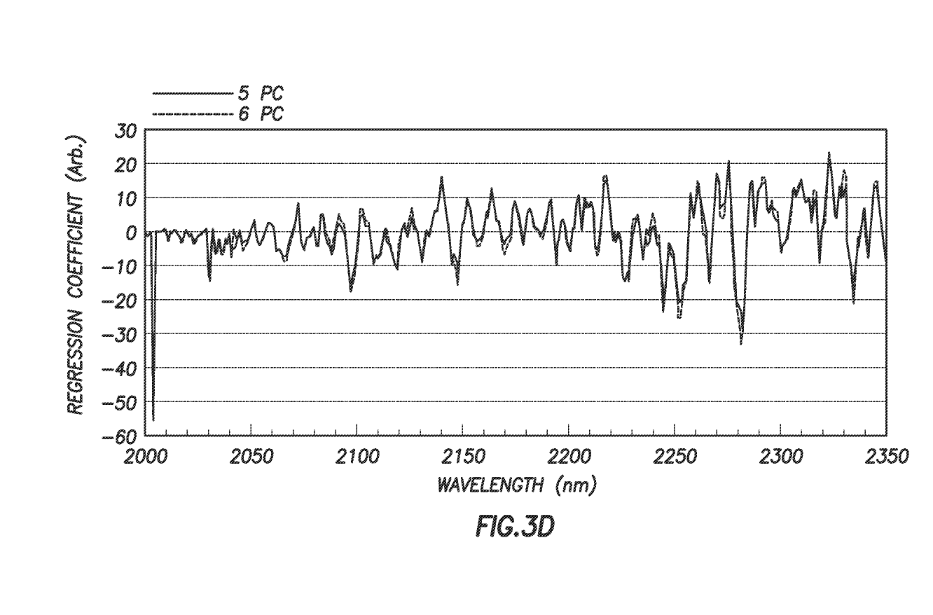

Regression vectors for each constituent or characteristic of the fluid phase may be determined using the techniques set forth herein. Data from pristine water and 27 field-produced water samples having various constituent concentrations and characteristic values was used to determine the regression vectors herein (see Experimental Examples for more details on the water samples). The regression vector for each constituent or characteristic of a fluid phase may have a specific shape, given that the various constituents may perturb the spectrum of a matrix to differing degrees (see FIGS. 2A and 2B). FIGS. 3A-3D show regression vectors determined for chloride, sulfate, total boron, and total iron, respectively, over the wavelength range of 2000 nm to 2350 nm. Comparing the regression vectors to one another, one can see that differences exist between them. Further, for a given constituent, subtle differences exist in the regression vectors depending on the number of principal components used (see FIGS. 3A-3D). Regression vectors determined using both 5 and 6 principal components are presented in FIGS. 3A-3D.

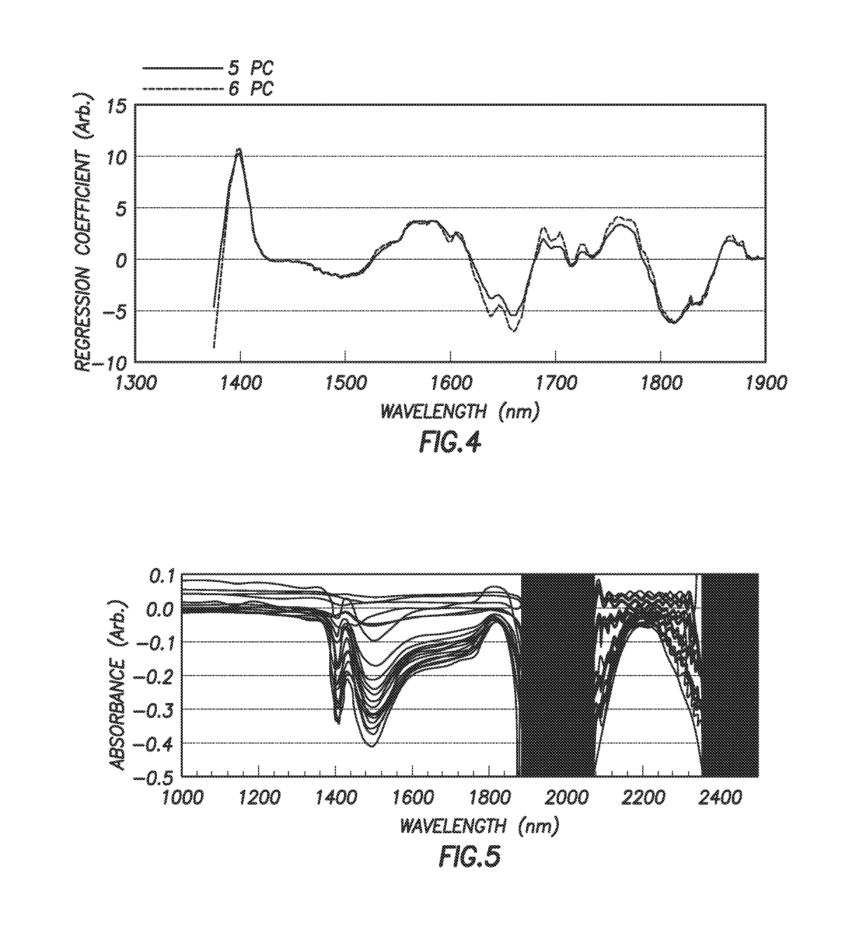

Regression vectors for characteristics may also be determined in a like manner. FIG. 4 shows a regression vector determined for specific gravity over the wavelength range of 1375 nm to 1900 nm. Regression vectors determined using both 5 and 6 principal components are presented in FIG. 4. Regression vectors may also be determined for other characteristics, as set forth above.

In some embodiments, the techniques described herein may be used to analyze a fluid phase to determine if at least one property of the fluid phase lies within a desired range. In some embodiments, the techniques described herein may be used to analyze the fluid phase of a treatment fluid, which may include any constituent therein. In some embodiments, the techniques may be used to analyze the fluid phase of a treatment fluid before treatment fluid is introduced into a subterranean formation or while the treatment fluid is being introduced into a subterranean formation. For analyses that are conducted before introducing the treatment fluid into the subterranean formation, the fluid phase may be static or it may be in motion. For analyses that are conducted while introducing the treatment fluid into the subterranean formation, the analyses may typically be conducted with the fluid phase in motion, although treatment fluid flow may be stopped momentarily for analysis, if desired. In either case, analyzing the treatment fluid before or while introducing the treatment fluid to a subterranean formation may allow a problematic treatment fluid to be identified and addressed. In various embodiments, addressing a problematic treatment fluid may comprise stopping the treatment operation, repeating the treatment operation, performing a remediation operation, replacing the treatment fluid, and/or modifying the treatment fluid in order to address an out-of-range condition. In some or other embodiments, the techniques described herein may be used to analyze the fluid phase of a treatment fluid while the treatment fluid is located within a subterranean formation.

In some embodiments, the techniques described herein may be used to analyze a fluid phase (e.g., of a treatment fluid) before or while introducing the fluid phase into a vessel, such as a storage tank or a pipeline. For analyses that are performed before introducing the fluid phase into the vessel, the fluid phase may be static or in motion during the analysis. In some embodiments, the techniques may be used to analyze a fluid phase while in the vessel, such that changes that occur to the fluid therein may be determined.

In some embodiments, the methods described herein may further comprise determining if a treatment fluid is suitable for being introduced into a subterranean formation (e.g., to determine if at least one property is within a desired range). Given the benefit of the analyses described herein and knowing the type of subterranean formation and the type of treatment operation being conducted, one of ordinary skill in the art will be able to make a determination of the suitability of a treatment fluid for a given situation. For example, a treatment fluid may contain a constituent that is incompatible with the formation matrix, or the treatment fluid may have a property that makes it incapable of performing a desired function in the subterranean formation.

In some embodiments, the suitability of a treatment fluid for a given application may be made in real-time or near real-time. In some embodiments, the suitability of a treatment fluid for a given application may be made automatically, such as with a computer or like processing means.

In some embodiments, if the treatment fluid is determined to be unsuitable for a given application, the present techniques may further comprise altering a concentration of at least one constituent of the treatment fluid, altering at least one characteristic of the treatment fluid, or any combination thereof. Such alteration may make the treatment fluid suitable for its intended purpose. In some embodiments, alteration may comprise adding more of or removing at least some of a constituent already present in the treatment fluid, in some embodiments, alteration may comprise adding another constituent to the treatment fluid that is not already present. Adding more of or removing at least some of an existing constituent or adding a new constituent may make the concentration of the constituent or a characteristic related thereto suitable for introduction to the subterranean formation. For example, in some embodiments, a treatment fluid having a high concentration of a metal constituent may be altered by adding a chelating agent that is at least partially specific for the metal, thereby reducing its effective concentration. In other embodiments, a treatment fluid may be altered by adjusting its acidity. In still other embodiments, a treatment fluid may be altered to adjust its viscosity. In yet other embodiments, a treatment fluid may be altered without addition of a constituent thereto or removal of a constituent therefrom. For example, in some embodiments, a treatment fluid may be allowed to stand for a period of time to allow a concentration or characteristic to change with the passage of time. In other embodiments, a treatment fluid may be heated, cooled or exposed to ultraviolet light, for example, to change a concentration or characteristic. Other types of related alterations for a treatment fluid or like fluid phase may be envisioned by one having ordinary skill in the art. In some embodiments, the methods may further comprise analyzing the fluid phase of the treatment fluid following its alteration. Thus, the present techniques may be used to determine if the alteration has had its desired effect. In some embodiments, altering the treatment fluid may take place before introducing the treatment fluid into a subterranean formation or a vessel. In other embodiments, altering the treatment fluid may take place on-the-fly while introducing the treatment fluid into a subterranean formation or a vessel. In still other embodiments, altering a treatment fluid may take place after introduction to a subterranean formation or a vessel. In some embodiments, a fluid phase (e.g., of a treatment fluid) may be exposed to electromagnetic radiation after being added to a subterranean formation or to a vessel so as to determine its behavior therein.

In some embodiments, altering a treatment fluid or like fluid phase may take place automatically under computer control or like processing means. For example, if an out-of-range condition is detected in the treatment fluid, the treatment fluid may be adjusted automatically in an attempt to correct the out-of-range condition. In some embodiments, an artificial neural network may be used to make predictive calculations of how to alter a treatment fluid in a desired way, particularly if a constituent that is not already present is being added. Use of an artificial neural network may be particularly desirable when the treatment fluid composition is far from that of its optimal composition. In this case, the artificial neural network may be used to assist in the formulation of treatment fluids having a custom formulation.

In some embodiments, providing a treatment fluid for introduction to a subterranean formation may comprise blending a fluid phase and at least one constituent. In some embodiments, the fluid phase may comprise an aqueous fluid. In some embodiments, the fluid phase may comprise water. In some or other embodiments, the fluid phase may comprise an oleaginous fluid, such as a drilling mud, for example. In some embodiments, the fluid phase may comprise a produced aqueous fluid, such as a produced water, for example. In some embodiments, the fluid phase may comprise a mixture of an oleaginous fluid and an aqueous fluid. In some embodiments, the fluid phase may be analyzed by the present techniques before being combined with the constituent(s) to form the treatment fluid. Thus, the present techniques may be used to determine if the fluid phase is even capable of producing a treatment fluid having desired properties. For example, a fluid phase having an unwanted constituent, or too much or too little of a desired constituent, would be less likely to produce a treatment fluid having desired properties when combined with another constituent. Thus, the present techniques may allow a treatment fluid to be analyzed at various points during its formation and use, thereby potentially reducing costs associated with poor quality treatment fluids that ultimately have to be disposed of or reformulated. For example, in some embodiments, a treatment fluid may be formed, analyzed, and then stored for a period of time prior to introduction to a subterranean formation. The techniques described herein may be used to determine if the treatment fluid remains suitable for use following its time in storage or transit to a job site.

Although the foregoing techniques may be used to analyze the fluid phase of any type of treatment fluid, the techniques may be particularly advantageous when applied to fracturing fluids, acidizing fluids, or a combination thereof (e.g., a fracture-acidizing fluid). As discussed in detail herein, incompatibilities are particularly common with these types of treatment fluids, and the present techniques may allow the suitability of these types of treatment fluids to be better determined. In other embodiments, the techniques may be used to analyze drilling fluids, conformance control fluids, sealants, cements, scale inhibitor fluids, biocidal fluids, and the like.

The ability to analyze a treatment fluid both before and after its formation may be particularly advantageous when using produced water or other produced aqueous fluids as the fluid phase of a treatment fluid. As described above, reuse of produced aqueous fluids in subterranean treatment operations may be desirable from a cost and environmental standpoint. However, the as-obtained produced aqueous fluids may be unsuitable for some applications, or they may only become suitable after being further altered in some manner, as described above. The ability to determine the suitability of produced aqueous fluids for a given application may be further complicated by the complexity of these fluids and the difficulties in quickly analyzing them by conventional analytical techniques.

In some embodiments, methods described herein can comprise: providing a produced aqueous fluid from a subterranean formation; exposing the produced aqueous fluid to electromagnetic radiation in a spectral region where water comprising the produced aqueous fluid optically interacts with electromagnetic radiation, so as to acquire a spectrum of the water; analyzing the spectrum of the water to determine at least one property of the produced aqueous fluid, the at least one property of the produced aqueous fluid being selected from the group consisting of a concentration of at least one constituent in the produced aqueous fluid, at least one characteristic of the produced aqueous fluid, and any combination thereof; and optionally, altering a concentration of at least one constituent in the produced aqueous fluid, altering at least one characteristic of the produced aqueous fluid, or any combination thereof. Alteration of the at least one concentration or the at least one characteristic may take place as described above.

In some embodiments, the methods may further comprise re-introducing the produced aqueous fluid into a subterranean formation, the subterranean formation comprising the same subterranean formation that produced the aqueous fluid or a different subterranean formation. For example, in some embodiments, a produced aqueous fluid that is sufficiently free of contaminants may be reintroduced to a subterranean formation simply as a means of disposal. In other embodiments, the produced aqueous fluid may be altered to make it suitable for reintroduction to a subterranean formation as a means of disposal. In some embodiments, the methods may further comprise forming a treatment fluid comprising the produced aqueous fluid, before re-introducing the produced aqueous fluid into the subterranean formation.

Various types of treatment fluids may be formulated using a produced aqueous fluid and analyzed by the foregoing techniques. In some embodiments, the treatment fluid may comprise a fracturing fluid, an acidizing fluid, or any combination thereof, for example. Other types of treatment fluids that may be formed from produced aqueous fluids may also be envisioned by one having ordinary skill in the art, such as, for example, drilling fluids, scale inhibitor fluids, biocidal fluids, or any combination thereof. Depending on the intended treatment operation, the constituents and characteristics of the water being analyzed will likely vary from application to application, as described previously. For example, when performing a fracturing operation, certain ionic species, if present, may impact the outcome of a fracturing operation. Likewise, in an acidizing operation, particularly of a siliceous subterranean formation, the presence of calcium ions or alkali metal ions in the fluid phase may cause precipitate formation that can damage the subterranean formation.

Illustrative substances that may be present in any of the treatment fluids described herein include, for example, acids, acid-generating compounds, bases, base-generating compounds, surfactants, scale inhibitors, corrosion inhibitors, gelling agents, crosslinking agents, anti-sludging agents, foaming agents, defoaming agents, antifoam agents, emulsifying agents, de-emulsifying agents, iron control agents, proppants or other particulates, gravel, particulate diverters, salts, fluid loss control additives, gases, catalysts, clay control agents, chelating agents, corrosion inhibitors, dispersants, flocculants, scavengers (e.g., H₂S scavengers, CO₂ scavengers or O₂ scavengers), lubricants, breakers, delayed release breakers, friction reducers, bridging agents, viscosifiers, weighting agents, solubilizers, rheology control agents, viscosity modifiers, pH control agents (e.g., buffers), hydrate inhibitors, relative permeability modifiers, diverting agents, consolidating agents, fibrous materials, bactericides, tracers, probes, nanoparticles, and the like. Combinations of these substances can be used as well.

To facilitate a better understanding of the present invention, the following examples of preferred or representative embodiments are given. In no way should the following examples be read to limit, or to define, the scope of the invention.

### EXAMPLES

### Example 1

### Analysis of Field-Produced Water Samples Using Near-Infrared Spectroscopy

27 field-produced water samples from various sources were obtained, and near-infrared spectra for each were acquired over the wavelength range of 1000 nm-2500 nm at a cell path length of 2 mm. FIG. 5 shows an aggregate near-infrared absorption spectrum of the 27 field-produced water samples at a path length of 2 mm against a water reference. As can be seen from FIG. 5, the spectra were very complex, particularly in the regions of highest absorption, although subtle differences do exist between them.

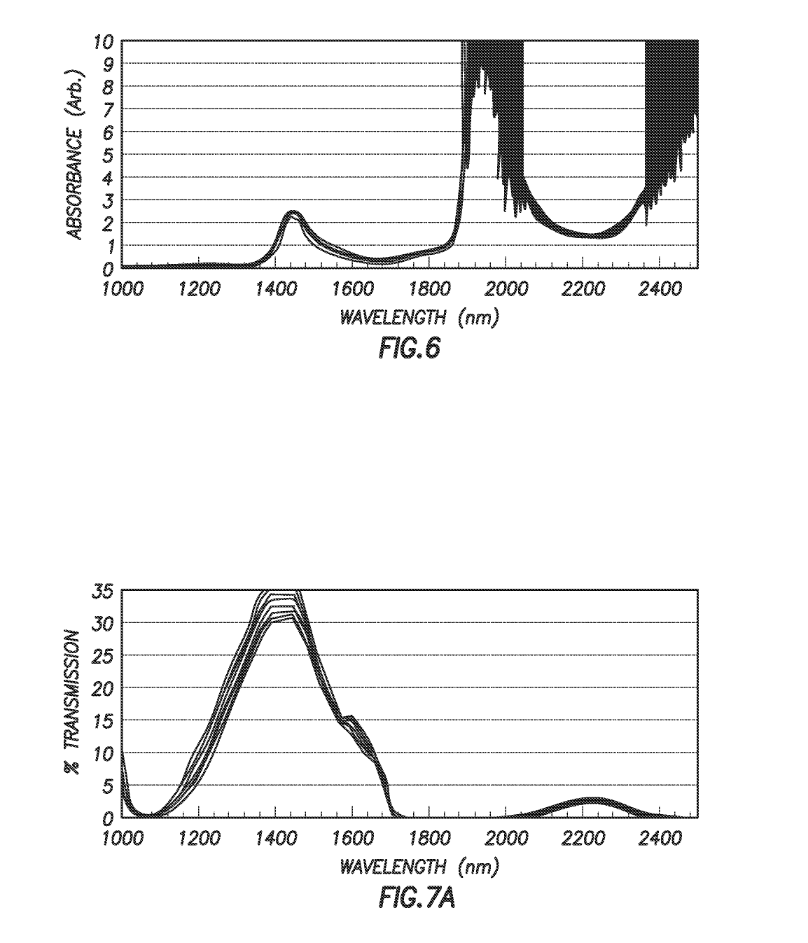

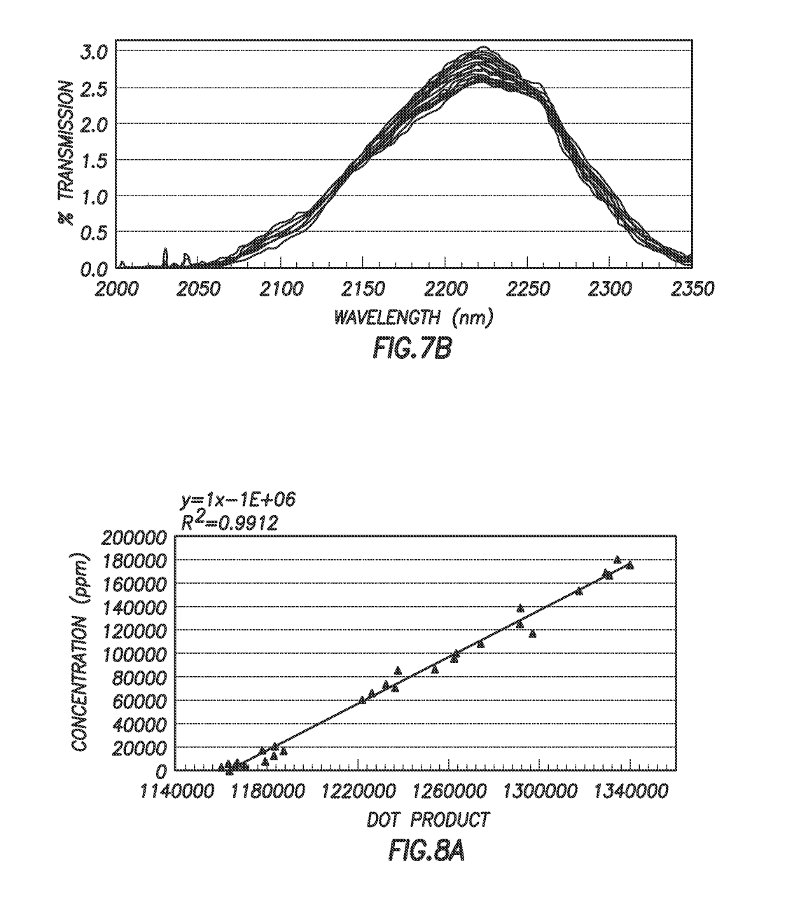

Following acquisition of the spectra, the spectra were normalized and converted into transmission spectra. FIG. 6 shows an aggregate near-infrared absorption spectrum of the 27 field-produced water samples at a path length of 2 mm against a water reference following normalization. As can be seen from FIG. 6, normalization considerably reduced the complexity of the individual spectra. FIGS. 7A and 7B show expansions of the data of FIG. 6 following conversion into transmission mode. Again, it can be seen that the individual spectra were distinct but very similar to one another. Further, it can be seen that the percent transmission is fairly low due to the strong absorbance of water in the spectral region of interest.

Experimental values for ionic concentrations of sodium, total iron, barium, magnesium, calcium, strontium, potassium, aluminum, total boron, bicarbonate, sulfate, and chloride were determined by an appropriate analytical technique for each sample. In addition, the samples were analyzed for their specific gravity, ionic strength, total dissolved solids, and pH values. The experimental concentrations and the values of the 27 water samples are summarized in Table 1. Concentration values are expressed in ppm units in the Table. Estimated or assumed values are marked with an asterisk. Estimated or assumed values were used when the analyzed value was below that of the analytical detection limit. In this case, the estimated or assumed value was taken to be half the value of the analytical detection limit.

TABLE 1

| | 1 | 2 | 3 | 4 | 5 | 6 | 7 |
|---|---|---|---|---|---|---|---|
| specific gravity | 1.0000 | 1.1750 | 1.1260 | 1.1440 | 1.1370 | 1.1580 | 1.1160 |
| pH | 7.0000 | 5.550 | 6.510 | 6.570 | 6.500 | 6.490 | 7.480 |
| ionic strength | 0.0000 | 4.7190 | 4.1070 | 3.9530 | 3.4520 | 4.1630 | 3.2190 |
| bicarbonate | 0.0000 | 122.0 | 1050.0 | 397.0 | 1.40.0 | 305.0 | 381.0 |
| chloride | 0.0000 | 166568 | 116443 | 138163 | 125263 | 152941 | 108227 |
| sulfate | 0.0000 | 385.6 | 1103.5 | 120.5 | 8834 | 800.4 | 810.8 |
| calcium | 0.0000 | 12100 | 3610 | 2560 | 1060 | 3160 | 5460 |
| magnesium | 0.0000 | 1400 | 634 | 1030 | 362 | 936 | 835 |
| barium | 0.0000 | 3.00 | 0.73 | 3.25 | 0.65 | 1.15 | 1.50 |
| strontium | 0.0000 | 655 | 364 | 805 | 207 | 483 | 256 |
| total iron | 0.0000 | 2.10 | 2.37 | 0.87 | 0.60 | 2.52 | 3.98 |
| aluminum | 0.0000 | 1.19 | 0.75 | 0.73 | 0.40 | 0.64 | 0.78 |
| boron | 0.0000 | 209.00 | 28.00 | 21.60 | 29.20 | 24.60 | 143.00 |
| potassium | 0.0000 | 3330 | 1180 | 1210 | 1230 | 1420 | 2080 |
| sodium | 0.0000 | 84500 | 64210 | 75900 | 73100 | 84700 | 57800 |
| total dissolved | 0.0000 | 253000 | 233000 | 224000 | 200000 | 235000 | 177000 |
| solids | | | | | | | |
| NOTES | | | | | | | |
| | 1 | 8 | 9 | 10 | 11 | 12 | 13 |
| specific gravity | 1.0000 | 1.1090 | 1.1920 | 1.1870 | 1.1870 | 1.1000 | 1.1060 |
| pH | 7.0000 | 7.680 | 4.660 | 5.980 | 6.531 | 9.431 | 6.977 |
| ionic strength | 0.0000 | 3.0900 | 5.6880 | 5.8940 | 5.7420 | 2.8400 | 2.8410 |
| bicarbonate | 0.0000 | 198.0 | 31.0 | 76.0 | 109.7 | 0.0 | 167.7 |
| chloride | 0.0000 | 99226 | 179708 | 175068 | 168525 | 84940 | 85641 |
| sulfate | 0.0000 | 602.7 | 210.9 | 106.6 | 211.0 | 3.8* | 3.8* |
| calcium | 0.0000 | 5610 | 15600 | 23600 | 28700 | 11200 | 10900 |
| magnesium | 0.0000 | 735 | 1440 | 3720 | 4270 | 262 | 543 |
| barium | 0.0000 | 1.88 | 8.09 | 4.32 | 2.53 | 1160.00 | 1050.00 |
| strontium | 0.0000 | 304 | 1130 | 1690 | 1130 | 2130 | 2020 |
| total iron | 0.0000 | 8.60 | 7.44 | 0.95 | 0.29 | 0.27 | 0.10 |
| aluminum | 0.0000 | 0.79 | 1.12 | 1.11 | 1.87 | 1.30 | 1.02 |
| boron | 0.0000 | 148.00 | 308.00 | 40.20 | 30.40 | 77.40 | 76.40 |
| potassium | 0.0000 | 2180 | 5380 | 1560 | 1390 | 894 | 955 |
| sodium | 0.0000 | 51700 | 83500 | 70200 | 67700 | 43400 | 42200 |
| total dissolved | 0.0000 | 170000 | 305000 | 295000 | 276000 | 147000 | 147000 |
| solids | | | | | | | |
| NOTES | | | | | | | |
| | 1 | 14 | 15 | 16 | 17 | 18 | 19 |
| specific gravity | 1.0000 | 1.0990 | 1.0720 | 1.0220 | 1.1200 | 1.0100 | 1.0730 |
| pH | 7.0000 | 6.826 | 6.625 | 7.628 | 7.229 | 6.847 | 7.429 |
| ionic strength | 0.0000 | 3.0640 | 1.8790 | 0.5190 | 3.3420 | 0.2980 | 2.0600 |
| bicarbonate | 0.0000 | 206.4 | 2193 | 270.9 | 322.5 | 567.7 | 206.4 |
| chloride | 0.0000 | 95189 | 60421 | 16158 | 17009 | 7900 | 65970 |
| sulfate | 0.0000 | 186.0 | 475.0 | 3.8 | 96.0 | 143.0 | 456.0 |
| calcium | 0.0000 | 10500 | 1090 | 1570 | 8550 | 257 | 4860 |
| magnesium | 0.0000 | 513 | 195 | 110 | 2 | 25 | 5 |
| barium | 0.0000 | 15.20 | 0.80 | 15.60 | 6.28 | 5.88 | 3.96 |
| strontium | 0.0000 | 813 | 242 | 239 | 647 | 51 | 324 |
| total iron | 0.0000 | 0.10 | 0.18 | 0.10 | 0.17 | 3.96 | 0.26 |
| aluminum | 0.0000 | 1.08 | 0.34 | 0.38 | 0.86 | 1.75 | 0.84 |
| boron | 0.0000 | 202.00 | 35.70 | 93.60 | 366.00 | 115.00 | 229.00 |
| potassium | 0.0000 | 3270 | 402 | 244 | 5410 | 40 | 3400 |
| sodium | 0.0000 | 48000 | 40400 | 8630 | 57400 | 5890 | 36500 |
| total dissolved | 0.0000 | 162000 | 107000 | 27600 | 184000 | 17200 | 114000 |
| solids | | | | | | | |
| NOTES | | | | | | | |
| | 1 | 20 | 21 | 22 | 23 | 24 | 25 |
| specific gravity | 1.0000 | 1.0150 | 1.0270 | 1.0740 | 1.0230 | 1.0760 | 1.0070 |
| pH | 7.0000 | 7.630 | 4.400 | 6.900 | 7.000 | 5.540 | 6.000 |
| ionic strength | 0.0000 | 0.3740 | 0.7710 | 2.1510 | 0.4804 | 0.1180 | 2.4336 |
| bicarbonate | 0.0000 | 1020.0 | 0.0 | 154.85 | 258.0 | 204.0 | 149.7 |
| chloride | 0.0000 | 5178 | 12494 | 69711 | 20358 | 3048 | 72744 |
| sulfate | 0.0000 | 241.0 | 204.0 | 2624.6 | 35.5 | 25.3 | 3.8* |
| calcium | 0.0000 | 68 | 1820 | 4770 | 594 | 445 | 10300 |
| magnesium | 0.0000 | 37 | 24 | 1080 | 21 | 17 | 394 |
| barium | 0.0000 | 0.08 | 14.10 | 0.24 | 7.09 | 0.79 | 276.00 |
| strontium | 0.0000 | 41 | 340 | 107 | 1740 | 6 | 1600 |
| total iron | 0.0000 | 0.16 | 19.40 | 2.03 | 0.61 | 2.45 | 42.70 |
| aluminum | 0.0000 | 0.59 | 1.88 | 0.63 | 0.18 | 1.61 | 0.87 |
| boron | 0.0000 | 61.50 | 40.30 | 15.20 | 48.10 | 50.30 | 267.00 |
| potassium | 0.0000 | 116 | 138 | 570 | 99 | 63 | 1390 |
| sodium | 0.0000 | 7950 | 12100 | 36100 | 7740 | 1526 | 30800 |
| total dissolved | 0.0000 | 21900 | 41354 | 113545 | 26569 | 6220 | 115597 |
| solids | | | | | | | |
| NOTES | | | | | visually | | oily and |
| | | | | | opaque | | visually |
| | | | | | | | opaque |

| | 1 | 26 | 27 | 28 |
|---|---|---|---|---|
| specific gravity | 1.0000 | 1.0070 | 1.0100 | 1.0100 |
| pH | 7.0000 | 7.090 | 7.910 | 7.710 |
| ionic strength | 0.0000 | 0.1702 | 0.2100 | 0.2482 |
| bicarbonate | 0.0000 | 529.0 | 812.8 | 890.2 |
| chloride | 0.0000 | 3473 | 4633 | 6068 |
| sulfate | 0.0000 | 96.0 | 348.5 | 294.3 |
| calcium | 0.0000 | 228 | 190 | 162 |
| magnesium | 0.0000 | 97 | 87 | 74 |
| barium | 0.0000 | 1.26 | 1.57 | 2.23 |
| strontium | 0.0000 | 13 | 20 | 23 |
| total iron | 0.0000 | 9.49 | 9.30 | 10.80 |
| aluminum | 0.0000 | 0.84 | 0.64 | 0.57 |
| boron | 0.0000 | 99.00 | 98.90 | 101.00 |
| potassium | 0.0000 | 68 | 83 | 98 |
| sodium | 0.0000 | 2030 | 2900 | 3680 |
| total dissolved | 0.0000 | 6850 | 9479 | 11892 |
| solids | | | | |
| NOTES | | oil- | oil- | oil- |
| | | contaminated | contaminated | contaminated |

Using the experimentally determined concentrations or values, a regression vector was determined for each ionic concentration or characteristic. The regression vectors for chloride, sulfate, total boron, and total iron are shown in FIGS. 3A-3D, respectively, and the regression vector for specific gravity is shown in FIG. 4. Regression vectors for the other constituents and characteristics were determined but are not shown herein. Regression vector determination was conducted using partial least squares (PLS) analysis and 5 or 6 principal components. PLS analysis was conducted using two different software protocols: MATLAB (Mathworks) and THE UNSCRAMBLER (Camo). We found that use of 5 to 6 principal components provided a sufficiently accurate estimation without overly modeling spectral noise. Additional details concerning determination of the regression vectors can be found in the Detailed Description hereinabove. It is to be noted that no data was excluded from the analyses, even for samples that were visually opaque or oily or that utilized estimated values. For purposes of the analyses presented herein, the regression vector for each ionic constituent or fluid phase characteristic can be considered to be a chart of the regression coefficient as a function of wavelength.

Using each experimental spectrum, the dot product of each regression vector was determined over the spectral region of interest. A scalar quantity was obtained from the dot product analysis (i.e., a real number) for each ionic constituent or fluid phase characteristic. The dot product of each regression vector was determined by multiplying the spectral intensity at a given wavelength by the regression coefficient at the same wavelength and summing the product over the entire wavelength region.

The result of the dot product analysis was then correlated with a concentration or characteristic of reference standards having a known concentration or characteristic value. In this instance, the known concentrations of the samples were used as the set of standard reference samples, rather than formulating a set of independent reference standards. Comparison of the dot product values of the 27 water samples to the known values from the calibration curves then allowed the water sample concentrations or characteristic values to be determined.

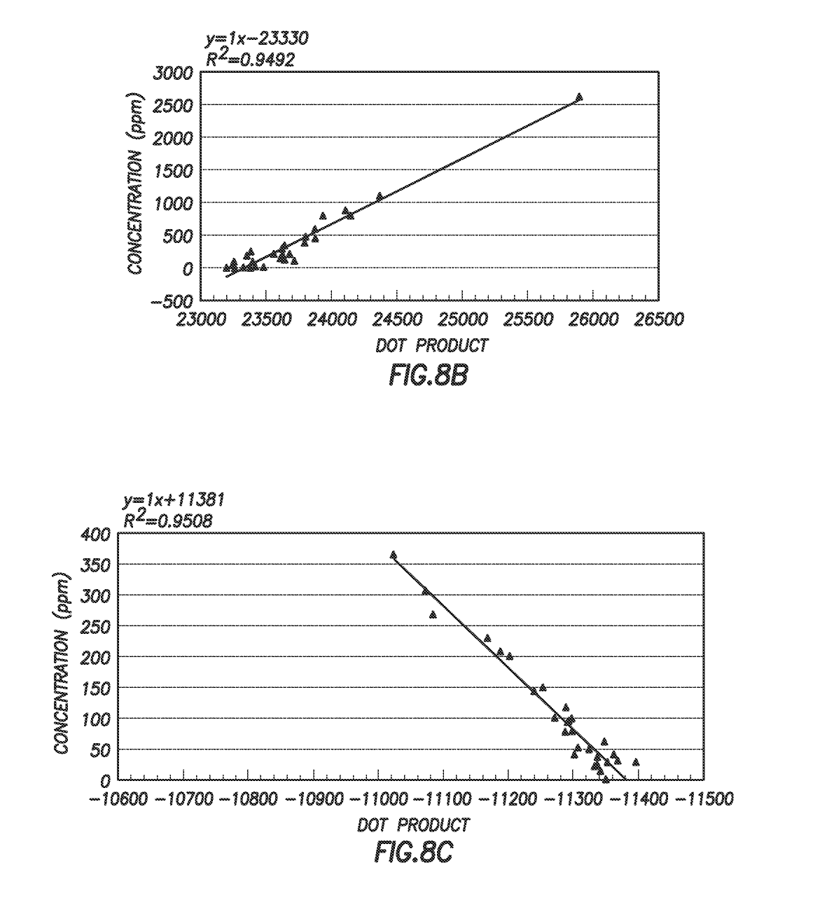

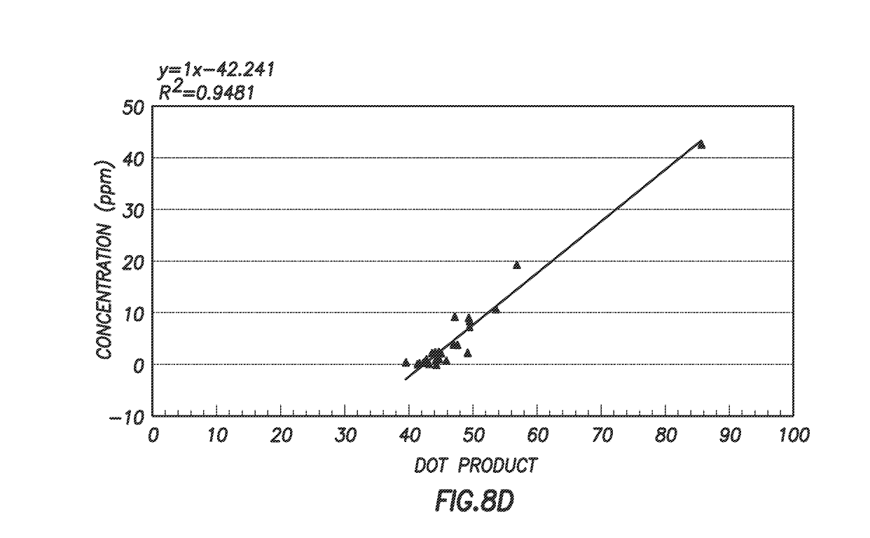

FIGS. 8A-8D show illustrative calibration curves for chloride, sulfate, total boron, and total iron, respectively. The dot product values in the calibration curves were obtained using the regression vectors (6 principal components) of FIGS. 3A-3E, respectively. In each case, the data was modeled with a linear least square fit, and an R² value of >0.94 was obtained in each instance.

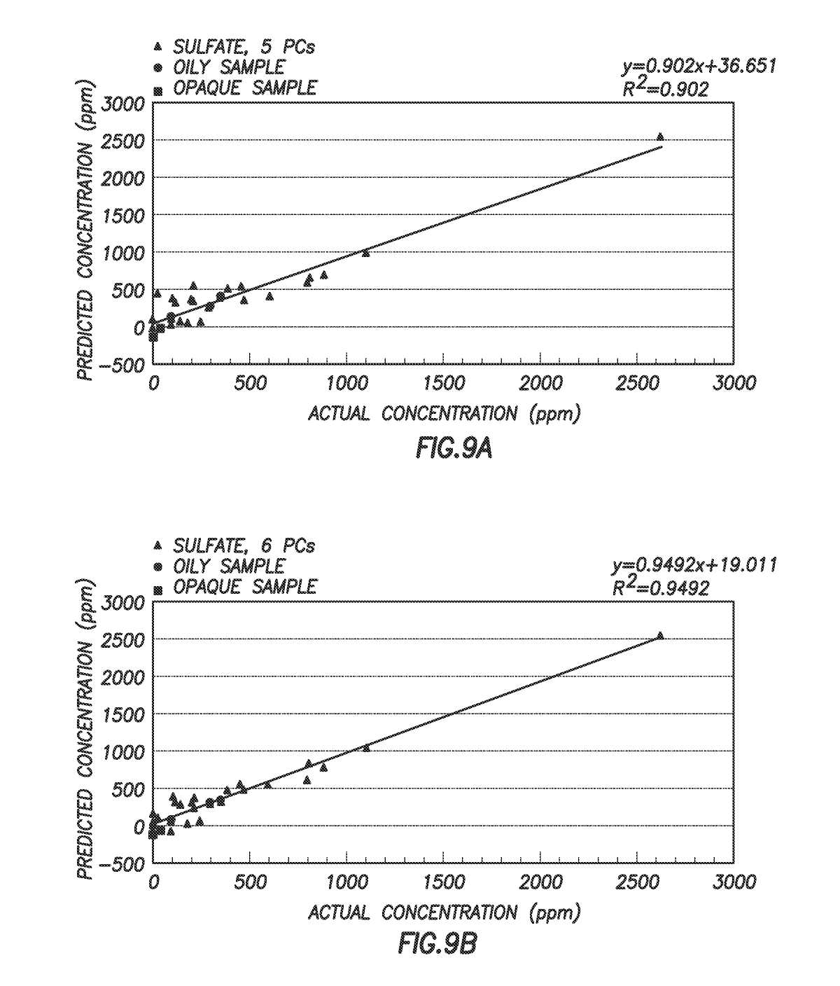

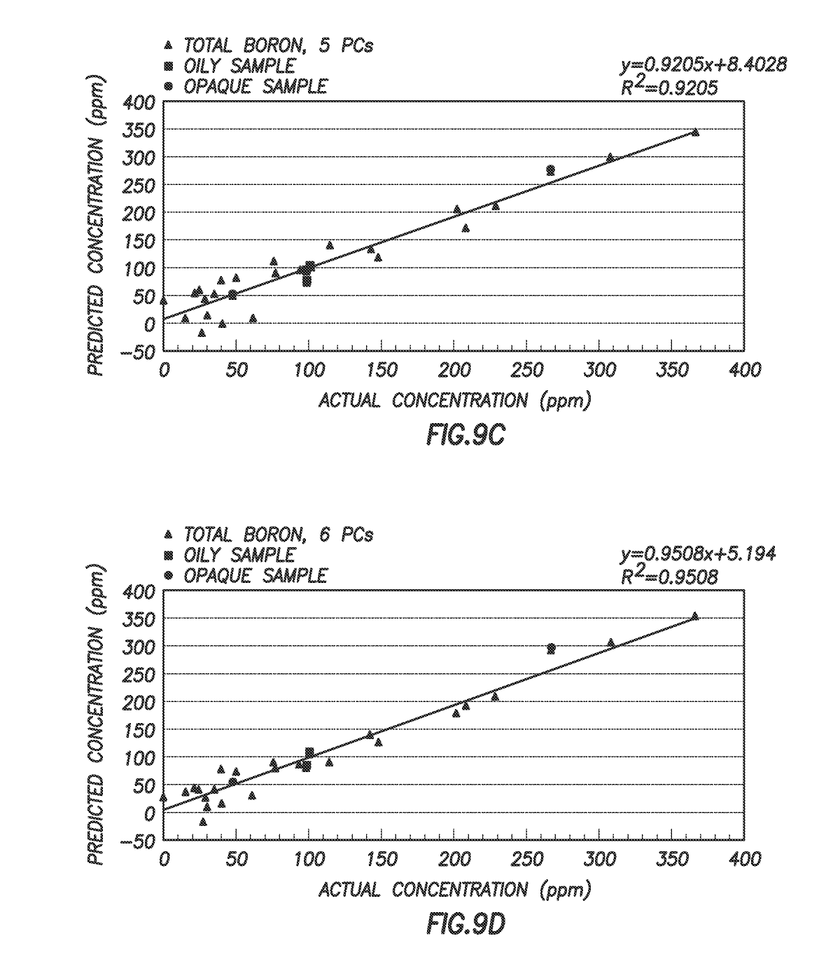

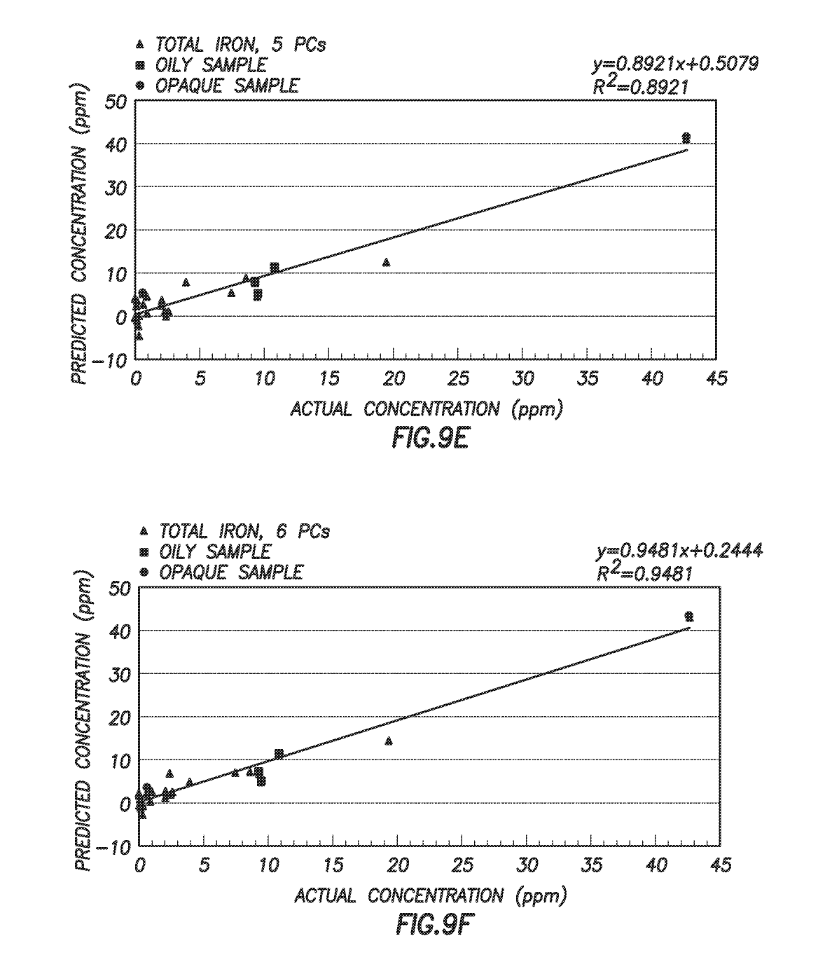

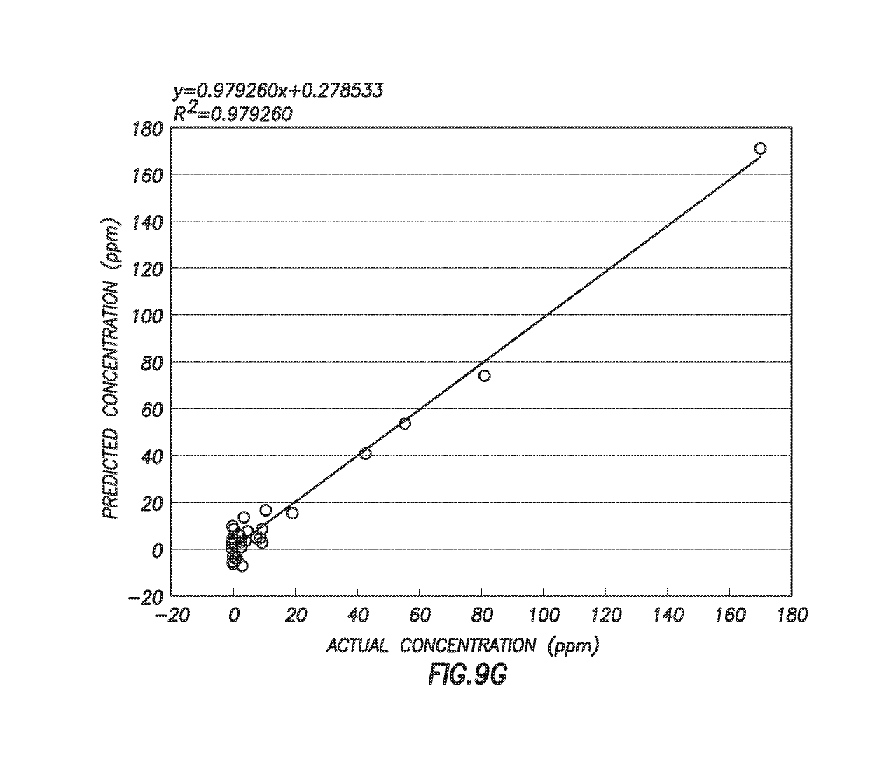

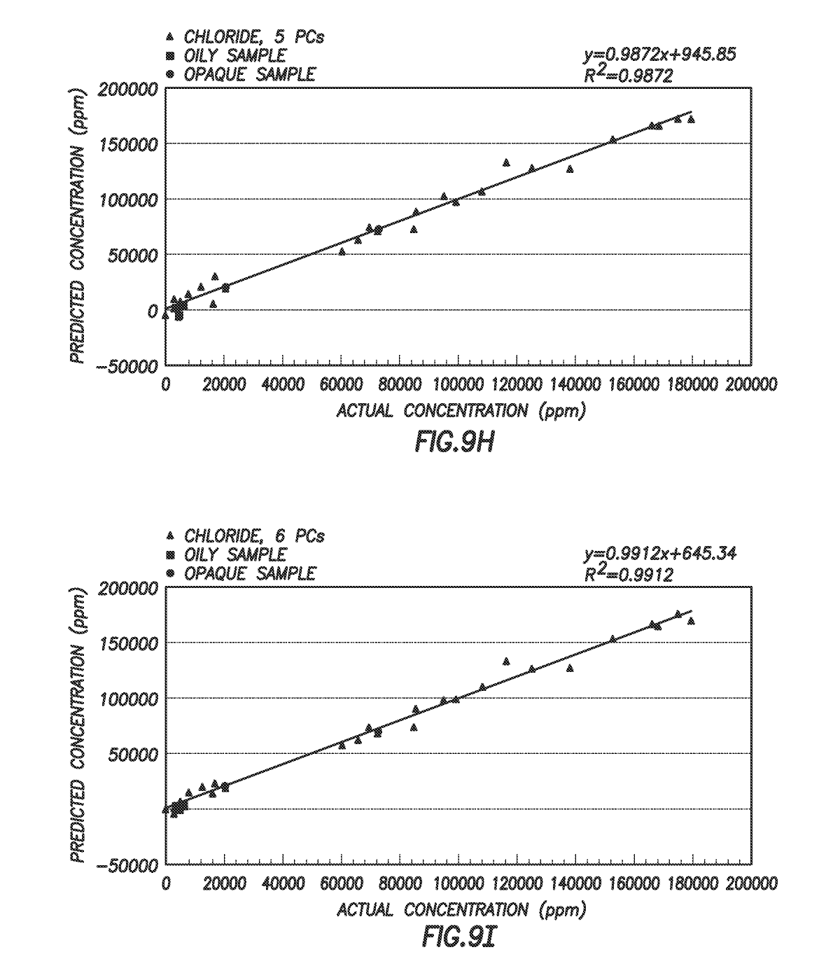

Comparison of the dot product values from the 27 water samples to the corresponding calibration curves for each constituent or characteristic produced good correlations with the experimentally determined values. FIGS. 9A-9I show illustrative plots of predicted concentration, as determined by dot product analysis, compared to the experimentally determined concentration. Predicted values using both 5- and 6-principal component regression vectors are presented (calibration curve data for 5-principal component regression vectors not shown herein). In each case, the data was modeled with a linear least squares fit, and an R² value of >0.89 was obtained in each instance. FIGS. 9A and 9B show plots of predicted versus experimental sulfate concentration for 5- and 6-principal components, respectively. FIGS. 9C and 9D show plots of predicted versus experimental total boron concentration for 5- and 6-principal components, respectively. FIGS. 9E and 9F show plots of predicted versus experimental total iron concentration for 5- and 6-principal components, respectively. FIG. 9G shows a plot of predicted versus experimental total iron concentration for 6-principal components with additional high iron concentration values included. FIGS. 9H and 9I show plots of predicted versus experimental chloride concentration for 5- and 6-principal components, respectively. It should be noted that a good fit was obtained even for samples that were visually opaque or oil-contaminated. In FIGS. 9A-9F, 9H, and 9I, samples that were “oily” or “opaque” have been indicated in the chart legend as such.

Table 2 summarizes the accuracies associated with the analyses described above for the 27 field-produced water samples. The data presented in Table 2 is that obtained for the 5-principal component regression vector. The wavelength range in Table 2 indicates the wavelength range over which the presented values were determined. It is to be recognized that conducting the analysis over a different wavelength range would produce a slightly different result.

TABLE 2

| | | | | Standard | |
|---|---|---|---|---|---|
| Concentration | | Standard | | Deviation/ | |
| or Property | | Deviation | | Full Range | |
| Analyzed | Analyzed Range | of Prediction | | (%) | Wavelength Range |
| specific gravity | 1-1.192 | 0.003 | | 1.3 | 1850 nm-2350 nm |
| ionic strength | 0-5.894 | 0.119 | | 2.0 | 1875 nm-2350 nm |
| total dissolved solids | 0-305,000 | 6827 | | 2.2 | 2025 nm-2325 nm |
| pH | 4.4-9.43 | 0.35 | | 7.0 | 1900 nm-2300 nm |
| sodium | 0 ppm-84700 ppm | 1472 | ppm | 1.7 | 1750 nm-2200 nm |
| calcium | 0 ppm-28700 ppm | 881 | ppm | 3.1 | 2125 nm-2350 nm |
| magnesium | 0 ppm-4270 ppm | 196 | ppm | 4.6 | 1875 nm-2325 nm |
| chloride | 0 ppm-179708 ppm | 8539 | ppm | 4.8 | 2175 nm-2350 nm |
| total iron | 0 ppm-42.7 ppm | 2.2 | ppm | 5.3 | 2000 nm-2300 nm |
| barium | 0 ppm-1160 ppm | 81 | ppm | 7.0 | 2025 nm-2300 nm |
| strontium | 0 ppm-2130 ppm | 152 | ppm | 7.1 | 2150 nm-2325 nm |
| potassium | 0 ppm-5410 ppm | 424 | ppm | 7.8 | 2100 nm-2350 nm |
| sulfate | 0 ppm-2625 ppm | 221 | ppm | 8.4 | 2075 nm-2325 nm |
| aluminum | 0 ppm-1.88 ppm | 0.16 | ppm | 8.7 | 2075 nm-2350 nm |
| bicarbonate | 0 ppm-1340 ppm | 120 | ppm | 9.0 | 2050 nm-2350 nm |
| borate | 0 ppm-366 ppm | 36 | ppm | 9.8 | 2150 nm-2350 nm |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” “having,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a sample comprising a matrix and one or more constituents therein;
exposing the sample to electromagnetic radiation in a spectral region where the matrix optically interacts with the electromagnetic radiation, so as to acquire a spectrum of the matrix; and
analyzing the spectrum of the matrix within a wavelength range where the matrix has a molar extinction coefficient of at least about 0.005 M⁻¹mm⁻¹ to determine at least one property of the sample, the at least one property of the sample being selected from the group consisting of a concentration of at least one constituent in the sample, at least one characteristic of the sample, and any combination thereof.

2. The method of claim 1, wherein at least some of the one or more constituents are substantially spectroscopically inactive in the spectral region.

3. The method of claim 1, wherein two or more properties of the sample are determined from a single spectrum of the matrix, the two or more properties being selected from the group consisting of two or more constituent concentrations, two or more characteristics of the sample, and one or more constituent concentrations and one or more characteristics of the sample.

4. The method of claim 1, wherein the matrix comprises a fluid phase.

5. The method of claim 4, wherein the fluid phase comprises water, an aqueous fluid, an oleaginous fluid, or any combination thereof.

6. The method of claim 1, wherein the one or more constituents comprise at least one ionic material.

7. The method of claim 6, wherein the at least one ionic material comprises an ion selected from the group consisting of sodium-containing ions, potassium-containing ions, strontium-containing ions, magnesium-containing ions, calcium-containing ions, barium-containing ions, aluminum-containing ions, carbon-containing ions, sulfur-containing ions, halogen-containing ions, boron-containing ions, manganese-containing ions, lithium-containing ions, cesium-containing ions, chromium-containing ions, arsenic-containing ions, lead-containing ions, mercury-containing ions, nickel-containing ions, copper-containing ions, zinc-containing ions, titanium-containing ions, and any combination thereof.

8. The method of claim 1, wherein the at least one characteristic of the sample comprises a physical property selected from the group consisting of pH, ionic strength, specific gravity, total dissolved solids, total suspended solids, viscosity, opacity, yield point, and any combination thereof.

9. The method of claim 1, wherein the spectral region comprises the near-infrared spectral region, the mid-infrared spectral region, or any combination thereof.

10. The method of claim 1, wherein analyzing the spectrum of the matrix takes place in real-time or near real-time.

11. A method comprising:
providing a sample comprising a matrix and a plurality of constituents therein;
exposing the sample to electromagnetic radiation in a spectral region where the matrix optically interacts with the electromagnetic radiation, so as to acquire a spectrum of the matrix;
wherein the constituents are substantially spectroscopically inactive in the spectral region; and
analyzing the spectrum of the matrix to determine at least one property of the sample, the at least one property of the sample being selected from the group consisting of a concentration of at least one constituent in the sample, at least one characteristic of the sample, and any combination thereof.

12. The method of claim 11, wherein the spectral region lies within a wavelength range of about 2000 nm to about 25000 nm.

13. The method of claim 11, wherein two or more properties of the sample are determined from a single spectrum of the matrix, the two or more properties being selected from the group consisting of two or more constituent concentrations, two or more characteristics of the sample, and one or more constituent concentrations and one or more characteristics of the sample.

14. The method of claim 11, wherein the matrix comprises a fluid phase.

15. The method of claim 14, wherein the fluid phase comprises water, an aqueous fluid, an oleaginous fluid, or any combination thereof.

16. The method of claim 11, wherein the one or more constituents comprise at least one ionic material.

17. The method of claim 16, wherein the at least one ionic material comprises an ion selected from the group consisting of sodium-containing ions, potassium-containing ions, strontium-containing ions, magnesium-containing ions, calcium-containing ions, barium-containing ions, aluminum-containing ions, carbon-containing ions, sulfur-containing ions, halogen-containing ions, boron-containing ions, manganese-containing ions, lithium-containing ions, cesium-containing ions, chromium-containing ions, arsenic-containing ions, lead-containing ions, mercury-containing ions, nickel-containing ions, copper-containing ions, zinc-containing ions, titanium-containing ions, and any combination thereof.

18. The method of claim 11, wherein the at least one characteristic of the sample comprises a physical property selected from the group consisting of pH, ionic strength, specific gravity, total dissolved solids, total suspended solids, viscosity, opacity, yield point, and any combination thereof.

19. The method of claim 11, wherein analyzing the spectrum of the matrix takes place in real-time or near real-time.
